(19) United States
(12) Patent Application Publication
(10) Pub. No.: US 2005/0064330 A1
(43) Pub. Date: Mar. 24, 2005

(54) Lithographic printing plate precursor

(75) Inventors: Keisuke Arimura, Shizuoka (JP); Takahiro Goto, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/945,926

(22) Filed: Sep. 22, 2004

(30) Foreign Application Priority Data
Sep. 22, 2003 (JP) P.2003-329758

(51) Int. Cl. G03C 1/76

(52) U.S. Cl. 430/270.1

(57) ABSTRACT

A lithographic printing plate precursor comprising, in this order, a support, an undercoat layer and a photosensitive layer containing an infrared absorber, a polymerization initiator, a polymerizable compound and a binder polymer, wherein the undercoat layer contains a polymer compound having an acid group, and Ra, ΔS and a45 of a surface of the support are satisfied with the following conditions (i) to (iii), respectively: (i) Ra: 0.2 to 0.40 μm, (ii) AS: 35 to 85%, (iii) a45: 25 to 55%, in which Ra, ΔS (%) and a45 are defined herein.

### FIELD OF THE INVENTION

The present invention relates to a negative working lithographic printing plate precursor and in particular, to a negative working lithographic printing plate precursor capable of achieving direct drawing by infrared laser light.

### BACKGROUND OF THE INVENTION

Hitherto, PS plates having a construction in which a lipophilic photosensitive resin layer is provided on a hydrophilic support have been widely used as a lithographic printing plate precursor, and desired printing plates have been generally obtained by a plate-making method in which mask exposure (surface exposure) is carried out through a lith film, and non-image areas are then dissolved and removed. In recent years, digitalization techniques of undergoing electronic processing, storage and outputting of image information using a computer have become widespread. And, a variety of new image outputting systems corresponding to these digitalization techniques have been put into practical use. As a result, a computer-to-plate (CTP) technique of directly producing printing plates by scanning light having high directivity, such as laser light, according to digitalized image information without using a lith film is earnestly desired, and it is an important technical problem to obtain a lithographic printing plate precursor adaptive thereto.

As such a lithographic printing plate precursor that can be subjected to scanning exposure a construction in which a lipophilic photosensitive resin layer (hereinafter sometimes referred to as “photosensitive layer”) containing a photosensitive compound capable of generating an active species such as radicals and Bronsted acids upon laser exposure is provided on a hydrophilic support was proposed and has already been put into the market, Negative working lithographic printing plates can be obtained by laser scanning such a lithographic printing plate precursor based on the digital information to generate an active species, insolubilizing the photosensitive layer by causing a physical or chemical change by this action, and subsequently developing the insolubilized photosensitive layer. In particular, negative working lithographic printing plate precursors comprising a hydrophilic support having thereon a photo-polymerization type photosensitive layer containing a photo-polymerization initiator with excellent photosensitive speed, an addition polymerizable ethylenically unsaturated compound, and a binder polymer soluble in an alkaline developing solution are known. Such lithographic printing plate precursors had a desired printing performance because of advantages including excellent producibility, simplicity of the development treatment, and good resolution and ink receptivity.

In such negative working lithographic printing plate precursors, for the sake of enhancing the adhesion between a photosensitive layer and a support and increasing the development and removal property of unexposed regions of a photosensitive layer, it is generally carried out to provide an undercoat layer between the support and the photosensitive layer (for example, see JP-A-2001-272787). However, in such negative working lithographic printing plate precursors, in the case of storage over a long period of time, in particular, under high-temperature and high-humidity conditions, the development and removal property lowered so that an effect for preventing greasing from occurrence was not satisfactory yet. For the sake of solving these problems, there are required such devices that the acid value of a binder polymer in the photosensitive layer is increased to enhance the developability and that a developing solution with a high pH is used. On the other hand, there was a problem in obtaining a printing performance such as resistance to printing due to damages of penetration of the developing solution.

### SUMMARY OF THE INVENTION

Accordingly, an object of the invention is to provide a negative working lithographic printing plate precursor comprising a support having thereon a photopolymerization type photosensitive layer, which is excellent in the resistance to printing, less in the generation of greasing, and high in the stability with time at the time of printing by image exposure and development even after storing over a long period of time under high-temperature and high-humidity conditions after the production.

For the sake of solving the foregoing problems, the present inventor made extensive and intensive investigations. As a result, it has been found that in a negative working lithographic printing plate precursor provided with a photo-polymerization type photosensitive layer, by successively providing an undercoat layer containing a polymer compound having an acid group and a photopolymerization type photosensitive layer on a support in which a surface roughness, a surface area ratio and a degree of steepness, all of which are a factor expressing the surface shape, fall within specified ranges, respectively, the resistance to printing is excellent, and the greasing is hardly generated.

Specifically, the lithographic printing plate precursor of the invention comprises:
a support having an undercoat layer and a photosensitive layer containing an infrared absorber, a polymerization initiator, a polymerizable compound, and a binder polymer successively laminated thereon, wherein
the undercoat layer contains a polymer compound having an acid group, and Ra, ΔS, and a45 of the surface of the support are satisfied with the following conditions (i) to (iii), respectively:
(i) Ra: 0.2 to 0.40 μm μ(ii)
(ii) ΔS: 35 to 85%
(iii) a45: 25 to 55%
   wherein
Ra represents a surface roughness,
ΔS is determined from a real area Sₓ determined by the approximate three-point method and a geometric measurement area S₀ and according to the following equation:
   ΔS(%)=(Sₓ−S₀)/S₀×100
   and
a45 represents an area rate of a part having a degree of inclination of 45° or more, which is obtained by extracting components having a wavelength of from 0.2 μm to 2 μm.

Here, the term “successively laminated” as referred to herein means that the undercoat layer and the photosensitive layer are provided in this order on the support and does not deny the presence of other layers to be provided depending upon the purpose (for example, an interlayer, a backcoat layer, and an overcoat layer).

In the lithographic printing plate precursor of the invention, it is preferable that the polymer compound having an acid group to be contained in the undercoat layer contains 20% by mole or more of a constitutional unit having an acid group in the side chain. Also, it is preferable that such a polymer compound having an acid group is a polymer compound having a sulfonic acid group or a carboxylic acid group. Further, it is more preferable that the binder polymer has a repeating unit represented by the following formula (A).

Formula (A)

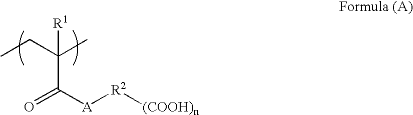

In the formula (A), R¹ represents a hydrogen atom or a methyl group; R² represents a connecting group (linking group) constituted of one or more atoms selected from the group consisting of a carbon atom, a hydrogen atom, an oxygen atom, a nitrogen atom, and a sulfur atom; A represents an oxygen atom or —NF³—; R² represents a hydrogen atom or a monovalent hydrocarbon group having from 1 to 10 carbon atoms; and n represents an integer of from 1 to 5.

The action of the invention will be described below.

In the lithographic printing plate precursor of the invention, the polymer compound having an acid group to be contained in the undercoat layer is excellent in the solubility in alkalis. Accordingly, it is considered that even after storing in the unexposed state over a long period of time, unexposed regions are developed and removed without generating residual films. Also, even by using a developing solution with a relatively low pH, the unexposed regions can stably exhibit good developability. In this way, it is possible to achieve good developability and shorten the contact time of image areas (exposed regions) with the developing solution under any development conditions. As a result, it is considered that damages of penetration are so small that printing performances such as resistance to printing are not hindered. In particular, by combining such an undercoat layer with a support having the foregoing specified surface shape, it is estimated that these effects are more enhanced.

On the other hand, in the photosensitive layer of the lithographic printing plate precursor of the invention, by using a binder polymer having a repeating unit represented by the formula (A), since the binder polymer is excellent in the diffusibility in a developing solution and the responsibility to alkalis (solubility in alkaline aqueous solutions), even when the acid content is slight (that is, in the case where the acid value is not sufficient), it is possible to add a function that the solubility in a developing solution is excellent. In this way, it is thought that the photosensitive layer of the lithographic printing plate precursor containing such a binder polymer can keep high developability while inhibiting damages of penetration of a developing solution caused by the acid content.

According to the invention, it is possible to provide a negative working lithographic printing plate precursor that is excellent in the resistance to printing, less in the generation of greasing, and high in the stability with time at the time of printing by image exposure and development even after storing over a long period of time under high-temperature and high-humidity conditions after the production thereof.

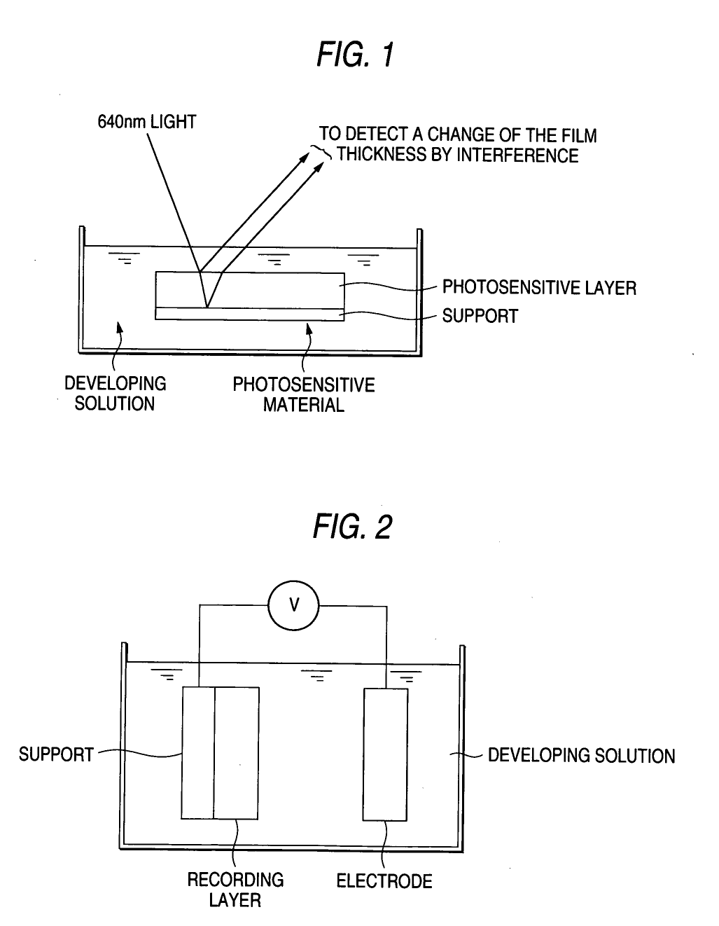

### BRIEF DESCRIPTION OF THE DRAWINGS

[FIG. 1]

An outline view showing one example of a DRM interference wave measuring instrument for measuring the dissolution behavior of a photosensitive layer.

[FIG. 2]

An outline construction view showing one example of a measurement method of the electrostatic capacity to be used for evaluating the penetration property of a developing solution into a photosensitive layer.

### DETAILED DESCRIPTION OF THE INVENTION

The lithographic printing plate precursor of the invention will be described below in detail.

The lithographic printing plate precursor of the invention comprises a support having an undercoat layer and a photosensitive layer containing an infrared absorber, a polymerization initiator, a polymerizable compound, and a binder polymer successively laminated thereon, wherein
the undercoat layer contains a polymer compound having an acid group, and Ra, ΔS, and a45 of the surface of the support are satisfied with the foregoing specified conditions (i) to (iii), respectively.

The respective members constituting the lithographic printing plate precursor of the invention will be described below.

Support

Examples of the support of the lithographic printing plate precursor of the invention include conventionally known metal plates that are in the dimensionally stable plate state (for example, aluminum, zinc, and copper) and papers or plastic films laminated with these metals. The surface of the support may be given hydrophilicity as the need arises, or may be subjected to an adequate known physical or chemical treatment for the purpose of enhancing the strength and so on.

An aluminum plate that is dimensionally stable and relatively cheap and can provide a surface excellent in the hydrophilicity and strength by a surface treatment as the need arises is especially preferable as the support. Also, a composite sheet comprising an aluminum sheet bonded on a polyethylene terephthalate film as described in JP-B-48-18327 is preferable.

In the invention, the aluminum plate that is suitable as the support is a metal plate containing dimensionally stable aluminum as the major component and is selected from not only a pure aluminum plate but also alloy plates containing aluminum as the major component and a slight amount of foreign elements, or plastic films or papers laminated with aluminum (or an alloy thereof). In the following description, the support made of the foregoing aluminum or aluminum alloy is generically called and used as an “aluminum support”. Examples of foreign elements to be contained in the foregoing aluminum alloy include silicon, iron, manganese, copper, magnesium, chromium, zinc, bismuth, nickel, and titanium, and the content of foreign elements in the alloy is not more than 10% by weight. In the invention, though the pure aluminum plate is suitable, since it is difficult to produce completely pure aluminum in view of the smelting technique, foreign elements may be contained in a slight amount. As described previously, the aluminum plate that is applied in the invention is not specified with respect to its formulation, but conventionally known and used materials such as JIS A1050, JIS A1100, JISA3103, and JIS A3005 can be adequately utilized.

Also, the thickness of the support to be used in the invention is from approximately 0.1 mm to 0.6 mm. This thickness can be adequately changed depending upon the size of a printing machine, the size of a printing plate, and the desire of a user.

Surface Shape of Support

In the invention, the support is required such that Ra, AS, and a45, all of which are a factor of the surface factor, are satisfied with the following conditions (i) to (iii), respectively.
(i) Ra: 0.2 to 0.40 μm
(ii) As: 35 to 85%
(iii) a45: 25 to 55%
(i) Ra represents a surface roughness. Here, the surface roughness (Ra) of the aluminum support as referred to herein means a center line average roughness (arithmetic average roughness) in the direction perpendicular to the rolling direction of aluminum and is expressed by a value (unit: μm) given by the following equation when a portion of the measurement length L is taken out in the center line direction from a roughness curve measured using a profilometer, the center line of the thus taken out portion is defined as an X-axis, whereas the axis perpendicular to the X-axis is defined as a Y-axis, and a roughness curve is expressed by Y=f(X). (The determination of L and the measurement of average roughness are according to JIS B0601.) Incidentally, even in the case of supports made of a material other than the aluminum support, the surface roughness (Ra) can be determined in the same manner.

$$Ra = \frac{1}{L} {\int }_{0}^{L} \vert f ( X ) \vert ⅆ X$$

In general, for the sake of enhancing the water holding property, it is effective to increase the surface roughness. However, if the surface roughness is increased, deep concaves are liable to be locally formed, and the deep concaves cause a development defect, thereby likely generating dotted residual films. Accordingly, it is required that Ra falls within the following range.

That is, in the invention, Ra must fall within the range of from 0.20 to 0.40 μm and is preferably in the range of from 0.20 to 0.35 μm, and more preferably in the range of from 0.25 to 0.35 μm.

As described below in detail, ΔS is determined from a real area Sₓ determined by the approximate three-point method and a geometric measurement area (apparent area) S₀ and according to the following equation from three-dimensional data determined by 512×512 point-measuring a portion of 50×50 μm of the surface of the support using an atomic force microscope.
ΔS(%)=(Sₓ−S₀)/S₀×100
The surface area ratio ΔS is a factor showing a degree of increase of the real area Sₓ by the roughing treatment against the geometric measurement area S₀.

When ΔS is large, the contact area with the undercoat layer becomes large, and as a result, it is possible to enhance the resistance to printing. However, when ΔS is too large, a development defect is caused, and therefore, it is required that ΔS falls within the following range.

That is, in the invention, ΔS must fall within the range of from 35 to 85% and is preferably in the range of from 40 to 85%, and more preferably in the range of from 40 to 80%.

As described below in detail, a45 represents an area rate of a part having a degree of inclination of 45° or more, which is obtained by extracting components having a wavelength of from 0.2 μm to 2 μm, from three-dimensional data determined by 512×512 point-measuring a portion of 50×50 μm of the surface of the support using an atomic force microscope.

The degree of steepness is a factor expressing a degree of sharpness of the fine shape of the surface of the support. Specifically, the degree of steepness represents a proportion of an area having an inclination of a certain angle or more to the real area in irregularities of the surface of the support. As a result of various investigations, the present inventor has found that this degree of steepness is correlated with the adhesion (resistance to printing) between the undercoat layer and the support and the ink adhesion (resistance to staining) of non-image areas, respectively. In particular, it has been found that by specifying the degree of steepness based on a specified angle of 45°, it is possible to make the resistance to printing and the resistance to staining cope with each other at a high grade.

More specifically, with respect to the area rate (degree of steepness) a45 of a slope having a degree of inclination of 45′ or more, in order to make the adhesion between the undercoat layer and the support excellent and to enhance the resistance to printing, it is preferred to make a45 larger. On the other hand, in order to inhibit catch of an ink in non-image areas and to enhance the resistance to staining, it is preferred to make a45 smaller. In view of these matters, it is required that a45 falls within the following range.

That is, in the inventions a45 must fall within the range of from 25 to 55% and is preferably in the range of from 30 to 55%, and more preferably in the range of from 30 to 50%.

In the support for lithographic printing plate in the invention, the methods of determining ΔS and a45 are as follows.

(1) Measurement of Surface Shape by Atomic Force Microscope:

is In the invention, in order to determine ΔS and a45, first of all, the surface shape is measured by an atomic force microscope (AFM) to determine three-dimensional data.

The measurement can be, for example, carried out under the following conditions. That is, a support is cut out into a size of 1 cm square and set on a horizontal sample table on a piezo scanner; a cantilever is approached to the surface of the sample; when it reaches a region where an atomic force is actuated, the sample is scanned in the XY-direction; and during this time, irregularities of the samples are caught by a displacement of the piezo in the Z-direction. As the piezo scanner, one capable of scanning 150 μm in the XY-direction and 10 μm in the Z-direction is used. As the cantilever, one having a resonance frequency of from 120 to 150 kHz and a spring constant of from 12 to 20 μm (SI-DF20, manufactured by NANOPROBE) is used, and the measurement is carried out at the dynamic force mode (DFM). Also, by subjecting the determined three-dimensional data to least square approximation, a slight inclination is corrected to determine a reference plane.

In the measurement, the surface of 50×50 μm is subjected to 512×512 point-measurement. The resolution in the XY-direction is set up at 1.9 μm, the resolution in the Z-direction is set up at 1 nm, and the scanning rate is set up at 60 μm/sec.

(2) Correction of Three-Dimensional Data:

In calculating ΔS, the three-dimensional data determined above in (1) are employed as they are. In calculating a45, data corrected by eliminating components having a wavelength of from 0.2 μm to 2 μm from the three-dimensional data are employed. By this correction, in the case where the surface having deep irregularities as in supports to be used in lithographic printing plate precursors is scanned by a probe of AFM, it is possible to eliminate noises generated when the probe touches the edge portion of a convex and jumps, or when a portion other than the tip of the probe contacts the side wall of a deep concave.

The correction is carried out by subjecting the three-dimensional data determined above in (1) to fast Fourier transformation to determine a frequency distribution and then eliminating components having a wavelength of from 0.2 μm to 2 μm therefrom to achieve Fourier inverse transformation.

(3) Calculation of Respective Factors:

Calculation of ΔS:

Using the three-dimensional data (f(x,y)) determined above in (1), three points adjacent to each other are extracted, and the total sum of areas of minute triangles is determined and defined as a real area Sₓ. The surface area ratio ΔS is determined from the resulting real area Sₓ and geometric measurement area S₀ and according to the following equation. So represents a geometric measurement area and is determined by S₀=Lₓ×L_{y}. In the invention, Lₓ=Y_{y}=50 μm.
ΔS(%)=(Sₓ−S₀)/S₀×100
Calculation of a45:

Using the three-dimensional data (f(x,y)) determined above in (2), three points adjacent to each other are extracted, and an angle between a minute triangle formed by these three points and the reference plane is calculated with respect to all data, to determine a distribution curve of degree of inclination. On the other hand, the total sum of areas of the minute triangles is determined and defined as a real area. A proportion a45 of a part having a degree of inclination of 45° or more to the real area is calculated from the distribution curve of degree of inclination.

In the invention, the support having the foregoing surface shape can be prepared by subjecting to a surface treatment described later.

A variety of surface treatments to be applied to the aluminum support will be described below. But, even in the case of supports made of other material, it is possible to subjecting them to the same surface treatment by adequately adjusting the treatment conditions.

(Roughing Treatment)

Examples of the roughing treatment include mechanical roughing, chemical etching, and electrolytic graining as disclosed in JP-A-56-28893. Further, an electrochemical roughing method of performing electrochemical roughing in a hydrochloric acid or nitric acid electrolytic liquid and mechanical roughing treatments such as a wire brush graining method of scratching the aluminum surface using a metallic wire, a ball graining method of sand blasting the aluminum surface using polishing spheres and a polishing agent, and a brush graining method of roughing the surface using a nylon brush and a polishing agent can be employed. The foregoing roughing methods can be employed singly or in combinations.

Of these methods, an electrochemical method of performing electrochemical roughing in a hydrochloric acid or nitric acid electrolytic liquid is useful as the roughing. A suitable quantity of electricity at the time of anodization is in the range of from 50 C/dM² to 400 C/dm². More specifically, it is preferable that alternating current and/or direct current electrolysis is carried out in an electrolytic liquid containing from 0.1 to 50% of hydrochloric acid or nitric acid under conditions at a temperature of from 20 to 80° C. for a time of from one second to 30 minutes and at a current density of from 10 A/dm² to 50 A/dm².

The roughed aluminum support may be chemically etched with an acid or an alkali. Examples of etching agents that are suitably used include sodium hydroxide, sodium carbonate, sodium aluminate, sodium metasilicate, sodium phosphate, potassium hydroxide, and lithium hydroxide. The concentration and the temperature are preferably in the range of from 1 to 50% and in the range of from 20 to 100° C., respectively. For the sake of removing stains (smuts) remaining on the surface after etching, acid washing is carried out. Examples of acids to be used include nitric acid, sulfuric acid, phosphoric acid, chromic acid, hydrofluoric acid, and borofluoric acid.

In particular, as the method of removing smuts after the electrochemical roughing treatment, a method of bringing into contact with sulfuric acid of from 15 to 65% by weight at a temperature of from 50 to 90° C. as described in JP-A-53-12739 and a method of performing alkali etching as described in JP-B-48-28123 are preferable.

In the invention, the method and conditions are not particularly limited thereto so far as after the treatment, Ra, ΔS and a45, all of which are a factor of the surface shape of the treated surface, are satisfied with the foregoing conditions (i) to (iii).

(Anodic Oxidation Treatment)

The thus roughed aluminum support having an oxide layer formed thereon is then subjected to an anodic oxidation treatment.

In the anodic oxidation treatment, an aqueous solution of sulfuric acid, phosphoric acid, oxalic acid, or boric acid/sodium borate is used singly or in combinations as the major component of an electrolytic bath. In this case, as a matter of course, the electrolytic liquid may contain components that are at least usually contained in an Al alloy plate, electrodes, city water, ground water, etc. Further, second or third components may be added to the electrolytic liquid. Examples of the second or third components as referred to herein include cations such as metal ions of Na, K, Mg, Li, Ca, Ti, Al, V, Cr, Mn, Fe, Co, Ni, Cu, Zn, etc. and an ammonium ion; and anions such as a nitric acid ion, a carbonic acid ion, a chlorine ion, a phosphoric acid ion, a fluorine ion, a sulfurous acid ion, a titanic acid ion, a silicic acid ion, and a boric acid ion. These second or third components may be contained in a concentration of from about 0 to 10,000 ppm. With respect to the conditions of the anodic oxidation treatment, the quantity of an anodically oxidized film prepared by the treatment is preferably in the range of from 0.5 to 10.0 g/m², and more preferably in the range of from 1.0 to 5.0 g/m². In general, the anodic oxidation treatment is preferably carried out by direct current or alternating current electrolysis in a concentration of the acid as the major component in the electrolytic liquid of from 30 to 500 g/L at a treatment liquid temperature of from 10 to 70° C. at a current density in the range of from 0.1 to 40 A/m².

(Hydrophilization Treatment)

As the hydrophilization treatment of the surface of the foregoing support, known methods can be widely applied. As an especially preferable treatment, the surface of the support is subjected to a hydrophilization treatment with a silicate or polyvinylphosphonic acid, etc. The film is preferably formed in an amount of from 2 to 40 mg/m², and more preferably from 4 to 30 mg/m² in terms of an element amount of Si or P. The coating amount can be measured by the fluorescent X-ray analysis method.

The foregoing hydrophilization treatment can be, for example, carried out by dipping the aluminum support having an anodically oxidized film formed thereon in an aqueous solution containing from 1 to 30% by weight, and preferably from 2 to 15% by weight of an alkali metal silicate or polyvinylphosphonic acid at a pH of from 10 to 13 at 25° C. for from 0.5 to 120 seconds at from 15 to 80° C.

Examples of the alkali metal silicate that is used in the foregoing hydrophilization treatment include sodium silicate, potassium silicate, and lithium silicate. Examples of a hydroxide that is used for the purpose of increasing the pH pf the alkali metal silicate aqueous solution include sodium hydroxide, potassium hydroxide, and lithium hydroxide. Incidentally, an alkaline earth metal salt or a salt of a metal belonging to the Group IVB may be compounded in the foregoing treatment liquid. Examples of the alkaline earth metal salt include water-soluble salts such as nitrates (for example, calcium nitrate, strontium nitrate, magnesium nitrate, and barium nitrate), sulfates, hydrochlorides, phosphates, acetates, oxalates, and borates. Examples of the salt of a metal belonging to the Group IVB include titanium tetra-chloride, titanium trichloride, potassium titanium fluoride, potassium titanium oxalate, titanium sulfate, titanium tetraiodide, zirconium oxide chloride, zirconium dioxide, zirconium oxychloride, and zirconium tetrachloride.

The alkaline earth metal salt or salt of a metal belonging to the Group IVB may be used singly or in combinations of two or more thereof. Such a metal salt is preferably used in an amount in the range of from 0.01 to 10% by weight, and more preferably in the range of from 0.05 to 5.0% by weight. Also, silicate electrodeposition described in U.S. Pat. No. 3,658,662 is effective.

Further, a surface treatment by combining an electro-lytically grained support disclosed in JP-B-46-27481, JP-A-52-58602, and JP-A-52-30503 with the foregoing anodic oxidation treatment and hydrophilization treatment is useful.

Undercoat Layer

One of the characteristic features of the invention resides in an undercoat layer containing a polymer compound having an acid group, and by providing this undercoat layer containing a polymer compound between the support and the photosensitive layer, hard staining with time is achieved. More specifically, the polymer compound having an acid group is a polymer compound containing at least one constitutional unit having an acid group in the side chain in the molecule, and preferably a polymer compound containing 20% by mole or more of a constitutional unit having an acid group in the side chain. Examples of such an acid group include acid groups having an acid dissociation index (pKa) of not more than 7; more preferably —COOH, —SO₃H, —OSO₃H, —PO₃H₂, —OPO₃H₂, —CONHSO₂, and —SO₂NHSO₂; and especially preferably —COOH and —SO₃H.

In the invention, examples of monomers that can be a constitutional unit having a sulfonic acid group in the side chain in the polymer compound to be used in the undercoat layer include monomers such as p-toluenesulfonic acid, 2-acrylamido-2-methylpropanesulfonic acid, ethylenesulfonic acid, 2-chloroethylenesulfonic acid, ethylenedisulfonic acid, 1-propene-1-sulfonic acid, 1-propene-2-sulfonic acid, 2-methyl-1,3-propenedisulfonic acid, 1-butene-1-sulfonic acid, 1-pentene-1-sulfonic acid, 1-hexene-1-sulfonic acid, 2-phenylethylenesulfonic acid, 1-methyl-2-phenylethylenesulfonic acid, 3-chloroallyl-sulfonic acid, allylsulfonic acid, 3-chloro-2-butenesulfonic acid, 3-chloromethallylsulfonic acid, methallylsulfonic acid, 3-methyl-2-butene-2-sulfonic acid, 3-phenylallylsulfonic acid, 3-phenylmethallylsulfonic acid, 2-benzylallylsulfonic acid, 2-chloro-4-styrenesulfonic acid, vinyltoluenesulfonic acid, and α-methylstyrenesulfonic acid. Also, monomers such as alkali metal salts, ammonium salts, and water-soluble amine salts of these acids can be enumerated. More preferably, the constitutional unit having a sulfonic acid group in the side chain is one derived from at least one monomer selected from the group consisting of p-styrenesulfonic acid, 2-acrylamido-2-methylpropanesulfonic acid, ethylenesulfonic acid, and alkali metal salts, ammonium salts and water-soluble amine salts of these acids.

In the invention, examples of monomers that can be a constitutional unit having a carboxylic acid group in the side chain in the polymer compound to be used in the undercoat layer include methacrylic acid, acrylic acid, itaconic acid, crotonic acid, maleic acid, esterified maleic acid, fumaric acid, and esterified fumaric acid.

Such a monomer having an acid group is adequately chosen singly or in admixture of two or more thereof and polymerized, or copolymerized with other monomer. In the case wherein such a monomer having an acid group is copolymerized with other monomer, any monomer can be used as a counterpart monomer so far as it is copolymerizable with the monomer having an acid group. Especially preferred examples thereof include alkyl acrylates (for example, methyl acrylate, ethyl acrylate, n-propyl acrylate, isopropyl acrylate, n-butyl acrylate, isobutyl acrylate, n-amyl acrylate, isoamyl acrylate, n-hexyl acrylate, 2-ethylhexyl acrylate, n-octyl acrylate, n-decyl acrylate, and 2-hydroxyethyl acrylate), alkyl methacrylates (for example, methyl methacrylate, ethyl methacrylate, n-propyl methacrylate, isopropyl methacrylate, n-butyl methacrylate, isobutyl methacrylate, n-amyl methacrylate, 2-ethylhexyl methacrylate, n-octyl methacrylate, n-decyl methacrylate, and 2-hydroxyethyl methacrylate), styrenes (for example, styrene, o-methylstyrene, m-methylstyrene, p-methylstyrene, 2,4-dimethylstyrene, 2,5-dimethylstyrene, 3,4-dimethylstyrene, 3,5-dimethylstyrene, 2,4,5-trimethyl-styrene, 2,4,6-trimethylstyrene, o-ethylstyrene, o-sec-bu-tylstyrene, o-tert-butylstyrene, p-fluorostyrene, 2,5-di-fluorostyrene, o-chlorostyrene, m-chlorostyrene, p-chloro-styrene, 2,4-dichlorostyrene, 2,5-dichlorostyrene, 2,6-di-chlorostyrene, 3,4-dichlorostyrene, p-bromostyrene, and p-cyanostyrene), acrylonitrile, methacrylonitrile, acryl-amide, N-sec-butylacrylamide, N-tert-butylacrylamide, N,N-dibutylacrylamide, and N-tert-butylmethacrylamide.

In the invention, the molecular weight range of the polymer compound having an acid group is not limited so far as the polymer compound having an acid group is soluble in solvents. As a general standard, the molecular weight is suitably in the range of from about 1,000 to about 1,000,000, preferably in the range of from 2,000 to 100,000, and most preferably in the range of from 10,000 to 100,000.

Also, the constitutional unit having an acid group in the side chain to be contained in the polymer compound can be used in an amount over a wide range, preferably in the range of from about 1 to 100% by mole, and more preferably in the range of 5 to 100% by mole.

In the invention, the polymer compound having an acid group can be synthesized by conventionally known methods. For example, the polymer compound having an acid group can be obtained by polymerization in the solution polymerization method, and if desired, the acid group of the formed polymer may be neutralized to collect the polymer. In the solution polymerization method, in general, the polymerization is carried out, for example, in a solvent capable of dissolving the starting monomer, such as isopropyl alcohol, in a nitrogen atmosphere in the presence of a polymerization initiator. Also, likewise the usual synthesis of latexes, the polymer may be obtained as an aqueous dispersion prepared by emulsifying the starting monomer in water using a surfactant and then emulsion polymerizing the emulsion using a polymerization initiator such as potassium persulfate. As a matter of course, the polymer may be collected as a solid.

The undercoat layer containing the foregoing polymer compound and other arbitrary components can be formed in the following method.

First of all, a coating solution for undercoat layer of undercoat layer components having the foregoing polymer compound dissolved in an organic solvent (for example, methanol, ethanol, and methyl ethyl ketone) or a mixed solvent thereof, water, or a mixed solvent of an organic solvent and water is prepared. Then, such a coating solution for undercoat layer is coated on the foregoing support having a specified surface shape in the invention, followed by drying to form an undercoat layer. Alternatively, the support is dipped in the coating solution for undercoat layer and then washed with water or cleaned by air, etc., followed by drying to form an undercoat layer.

The coating amount of the undercoat layer is preferably from 1 to 1,000 mg/m² more preferably from 1 to 50 mg/m², and further preferably from 5 to 20 mg/m². When the coating amount of the undercoat layer is less than 1 mg/m², the effect for inhibiting the generation of greasing is lowered. On the other hand, when it exceeds 1,000 mg/m², the resistance to printing and other properties of the lithographic printing plate after plate making may possibly be adversely affected.

Arbitrary components such as pH adjusters (for example, phosphoric acid, phosphorous acid, hydrochloric acid, and low-molecular organic sulfonic acids) and wetting agents (for example, saponin) can be added in this coating solution for undercoat layer.

Photosensitive Layer

The photosensitive layer according to the invention is a heat polymerizable negative working photosensitive layer containing an infrared absorber, a polymerization initiator, a polymerizable compound (often referred to as “addition polymerizable compound”), and a binder polymer as essential components. Such a heat polymerizable negative working photosensitive layer has a mechanism in which the polymerization initiator is decomposed by heat to generate a radical, and the polymerizable compound causes polymerization reaction due to the generated radical. Further, since the lithographic printing precursor of the invention has a photosensitive layer containing such essential components, it is especially suitable in plate making in which direct drawing is performed by laser light having a wavelength of from 300 to 1,200 nm and reveals high resistance to printing and image forming property as compared with the conventional lithographic printing plate precursors.

The respective components constituting the photosensitive layer of the lithographic printing plate precursor of the invention will be described below.

(Infrared Absorber)

In the case where the lithographic printing plate precursor of the invention is subjected to direct drawing (image formation) using a laser capable of emitting infrared light of from 760 to 1,200 nm as a light source, in general, it is essential to use an infrared absorber. The infrared absorber has a function to convert absorbed infrared light into heat and a function to generate an excited electron of the infrared absorber. In this case, a polymerization initiator (radical generating agent) described later causes heat decomposition due to the generated heat, thereby generating a radical. Alternatively, the excited electron of the infrared absorber moves into the polymerization initiator to generate a radical. The infrared absorber to be used in the invention is a dye or a pigment having an absorption maximum at a wavelength of from 760 nm to 1,200 nm.

As the dye, commercially available dyes and known dyes described in documents, for example, Dyes Handbook (compiled by The Society of Synthetic Organic chemistry, Japan, 1970) can be utilized. Specific examples thereof include dyes such as azo dyes, metal complex salt azo dyes, pyrazolone azo dyes, naphthoquinone dyes, anthraquinone dyes, phthalocyanine dyes, carbonium dyes, quinoneimine dyes, methine dyes, cyanine dyes, squalilium dyes, pyrylium dyes, and metal thiolate complexes.

Examples of preferred dyes include cyanine dyes described in JP-A-58-125246, JP-A-59-84356, and JP-A-60-78787; methine dyes described in JP-A-58-173696, JP-A-58-181690, and JP-A-58-194595; naphthoquinone dyes described in JP-A-58-112793, JP-A-58-224793, JP-A-59-48187, JP-A-59-73996, JP-A-60-52940, and JP-A-60-63744; squalilium dyes described in JP-A-58-112792; and cyanine dyes described in British Patent No. 434,875.

Also, near infrared absorbing sensitizers described in U.S. Pat. No. 5,156,938 are suitably used. Also, substituted aryl benzo(thio) pyrylium salts described in U.S. Pat. No. 3,881,924; trimethylthiapyrylium salts described in described in JP-A-57-142645 (U.S. Pat. No. 4,327,169); pyrylium based compounds described in JP-A-58-181051, JP-A-58-220143, JP-A-59-41363, JP-A-5984248, JP-A-59-84249, JP-A-59-146063, and JP-A-59-146061; cyanine dyes described in JP-A-59-216146; pentamethinethiopyrylium salts described in U.S. Pat. No. 4,283,475; and pyrylium compounds disclosed in JP-B-5-13514 and JP-B-5-19702 are preferably used. Also, as other preferred examples of the dye, near infrared absorbing dyes described as the formulae (I) and (II) in U.S. Pat. No. 4,756,993 can be enumerated.

Also, other preferred examples of the infrared absorbing dye in the invention include specified indolenine cyanine dyes described in Japanese Patent Application Nos. 2001-6326 and 2001-237840, as enumerated below.

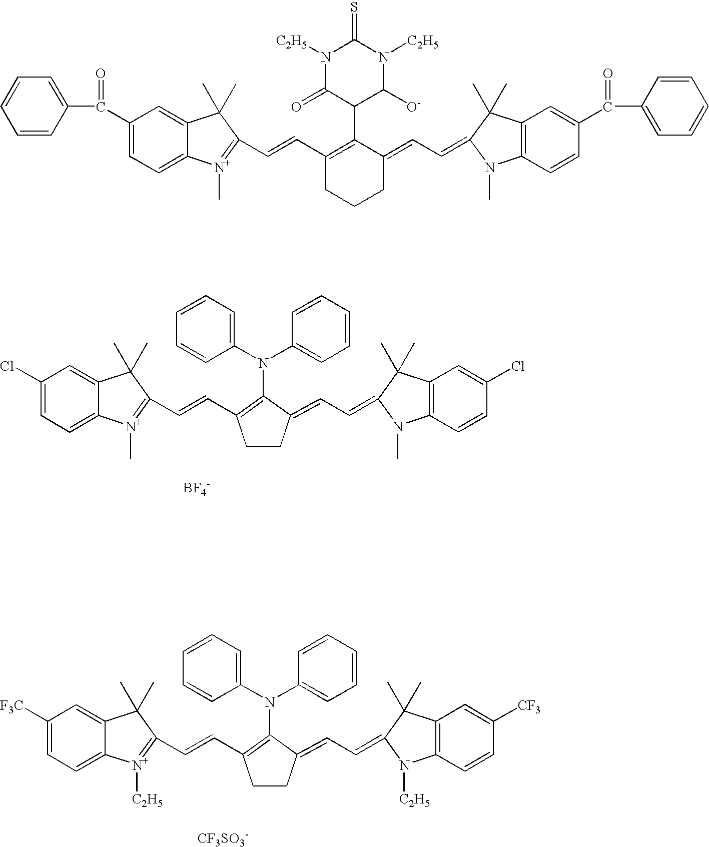

Of these dyes, cyanine dyes, squalilium dyes, pyrylium dyes, nickel thiolate complexes, and indolenine cyanine dyes are especially preferable. Further, cyanine dyes and indolenine cyanine dyes are preferable, and cyanine dyes represented by the following formula (a) are especially preferable.

Formula (a)

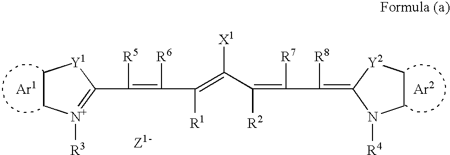

In the formula (a), X¹ represents a hydrogen atom, a halogen atom, —NPh₂, —X²-L¹, or a group described below. Here, X² represents an oxygen atom, a nitrogen atom, or a sulfur atom; and L¹ represents a hydrocarbon group having from 1 to 12 carbon atoms, a hetero atom-containing aromatic ring, or a hetero atom-containing hydrocarbon group having from 1 to 12 carbon atoms. Incidentally, the hetero atom as referred to herein represents N, S, O, a halogen atom, or Se. Xa is defined similarly as in Z¹⁻ described later; and R^{a} represents a substituent selected from a hydrogen atom, an alkyl group, an aryl group, a substituted or unsubstituted amino group, and a halogen atom.

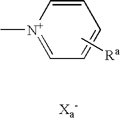

R¹ and R² each independently represents a hydrocarbon group having from 1 to 12 carbon atoms. In view of storage stability of the coating solution for photosensitive layer, it is preferable that R¹ and R² are each a hydrocarbon group having two or more carbon atoms. It is especially preferable that R¹ and R² are taken together to form a 5-membered ring or a 6-membered ring.

Ar¹ and Ar² may be the same or different and each represents an optionally substituted aromatic hydrocarbon group. Examples of preferred aromatic hydrocarbons include a benzene ring and a naphthalene ring. Also, examples of preferred substituents include a hydrocarbon group having not more than 12 carbon atoms, a halogen atom, and an alkoxy group having not more than 12 carbon atoms. Y¹ and Y² may be the same or different and each represents a sulfur atom or a di-alkylmethylene group having not more than 12 carbon atoms. R³ and R⁴ may be the same or different and each represents an optionally substituted hydrocarbon group having not more than carbon atoms. Examples of preferred substituents include an alkoxy group having not more than 12 carbon atoms, a carboxyl group, and a sulfo group. R⁵, R⁶, R⁷ and R¹ may be the same or different and each represents a hydrogen atom or a hydrocarbon group having not more than 12 carbon atoms, and in view of easiness of availability of the raw material, a hydrogen atom is preferable. Also, Zₐ⁻ represents a counter anion. However, in the case where the cyanine dye represented by the formula (a) has an anionic substituent in the structure thereof, and no neutralization of the charge is required, Zₐ³⁰ is not necessary. In view of storage stability of the coating solution for photosensitive layer, Z^{a}⁻ is preferably a halogen ion, a perchloric acid ion, a tetrafluoroborate ion, a hexafluorophosphate ion, or a sulfonic acid ion, and especially preferably a perchloric acid ion, a hexafluorophosphate ion, or an aryl sulfonic acid ion.

In the invention, specific examples of the cyanine dye represented by the formula (a), which can be suitably used, include ones described in paragraph Nos. [00171 to [0019] of JP-A-2001-133969.

Also, other especially preferred examples include specified indolenine cyanine dyes described in the foregoing Japanese Patent Application Nos. 2001-6326 and 2001-237840.

As the pigment that is used in the invention, commercially available pigments and pigments described in Color Index (C.I.) Handbook; Saishin Ganryc Binran (Current Pigment Handbook), compiled by Nippon Ganryo Pigment Kyokai (1977); Saishin Ganryo Ohyo Gijutsu (Current Pigment Application Technologies), published by CMC Publishing Co., Ltd. (1986); and Insatsu Inki Gijutsu (Printing Ink Technologies), published by CMC Publishing Co., Ltd. (1984) can be applied.

Examples of the pigment include black pigments, yellow pigments, orange pigments, brown pigments, red pigments, violet pigments, blue pigments, green pigments, fluorescent pigments, metal powder pigments, and other polymer-binding dyes. Specific examples include insoluble azo pigments, azo lake pigments, condensed azo pigments, chelate azo pigments, phthalocyanine based pigments, anthraquinone based pigments, perylene based pigments, perinone based pigments, thioindigo based pigments, quinacridone based pigments, dioxazine based pigments, isoindolinone based pigments, quinophthalone based pigments, dyeing lake pigments, azine pigments, nitroso pigments, nitro pigments, natural pigments, fluorescent pigments, inorganic pigments, and carbon black. Of these pigments, carbon black is preferable.

Such a pigment may be used without surface treatment or upon surface treatment. As the surface treatment method, there can be considered a method of coating the surface with a resin or a wax, a method of making a surfactant adhere, and a method of binding a reactive substance (for example, silane coupling agents, epoxy compounds, and polyisocyanates) to the pigment surface. These surface treatment methods are described in Kinzoku Sekken No Seishitsu To Ohyo (Properties and Applications of Metallic Soaps), published by Saiwai Shobo; Insatsu Inki Gijutsu (Printing Ink Technologies), published by CMC Publishing Co., Ltd. (1984); and Saishin Ganzyo Ohyo Gijutsu (Current Pigment Application Technologies), published by CMC Publishing Co., Ltd. (1986).

The particle size of the pigment is preferably in the range of from 0.01 μm to 10 μm, more preferably in the range of from 0.05 μm to 1 μm, and especially preferably in the range of from 0.1 μm to 1 μm. When the particle size falls within this range, excellent dispersion stability of the pigment in the coating solution for photosensitive layer is obtained, and a uniform photosensitive layer is obtained.

As a method of dispersing the pigment, known dispersion techniques that are used in the ink production or toner production can be employed. Examples of dispersion machines include an ultrasonic dispersion machine, a sand mill, an attritor, a pearl mill, a super mill, a ball mill, an impeller, a disperser, a KD mill, a colloid mill, a dynatron, a three-roll mill, and a pressure kneader. The details are described in Saishin Ganryo Ohyo Gijutsu (Current Pigment Application Technologies), published by CMC Publishing Co., Ltd. (1986).

Such an infrared absorber can be added in a proportion of from 0.01 to 50% by weight, and preferably from 0.1 to 10% by weight based oh the whole of solids constituting the photosensitive layer from the viewpoints of uniformity in the photosensitive layer and durability of the photosensitive layer. In the case of a dye, the infrared absorber can be added in a proportion of from 0.5 to 10% by weight, and in the case of a pigment, the infrared absorber can be added in a proportion of from 0.1 to 10% by weight.

(Polymerization Initiator)

The polymerization initiator that is used in the photosensitive layer of the lithographic printing plate precursor of the invention has a function to start and advance curing reaction of the polymerizable compound described later. Examples of such a polymerization initiator include onium salts, active halogen compounds, oxime ester compounds, and borate compounds. These compounds may be used jointly. In the invention, onium salts are preferable, and sulfonium salts are especially preferable.

Examples of the sulfonium salt polymerization initiator that is suitably used in the invention include an onium salt represented by the following formula (I).

Formula (I)

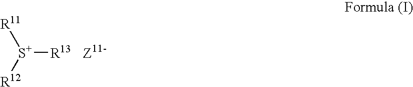

In the formula (I), R¹¹, R¹² and R¹³ may be the same or different and each represents an optionally substituted hydrocarbon group having not more than 20 carbon atoms. Examples of preferred substituents include a halogen atom, a nitro group, an alkyl group having not more than 12 carbon atoms, an alkoxy group having not more than 12 carbon atoms, and an aryloxy group having not more than 12 carbon atoms. Z¹¹⁻ represents a counter ion selected from the group consisting of a halogen ion, a perchloric acid ion, a tetrafluoroborate ion, a hexafluorophosphate ion, a carboxylate ion, and a sulfonic acid ion. Of these, a perchloric acid ion, a hexa-fluorophosphate ion, a carboxylate ion, and an aryl sulfonic acid ion are preferable.

Specific examples of the onium salt represented by the formula (I) ([OS-1] to [OS-12]) will be given below, but it should not be construed that the invention is limited thereto.

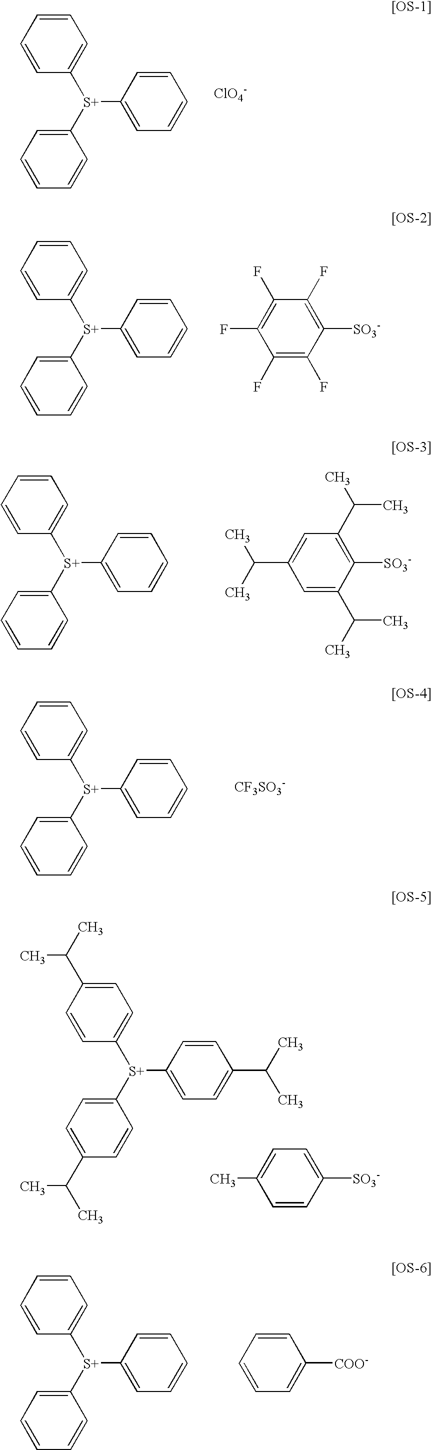

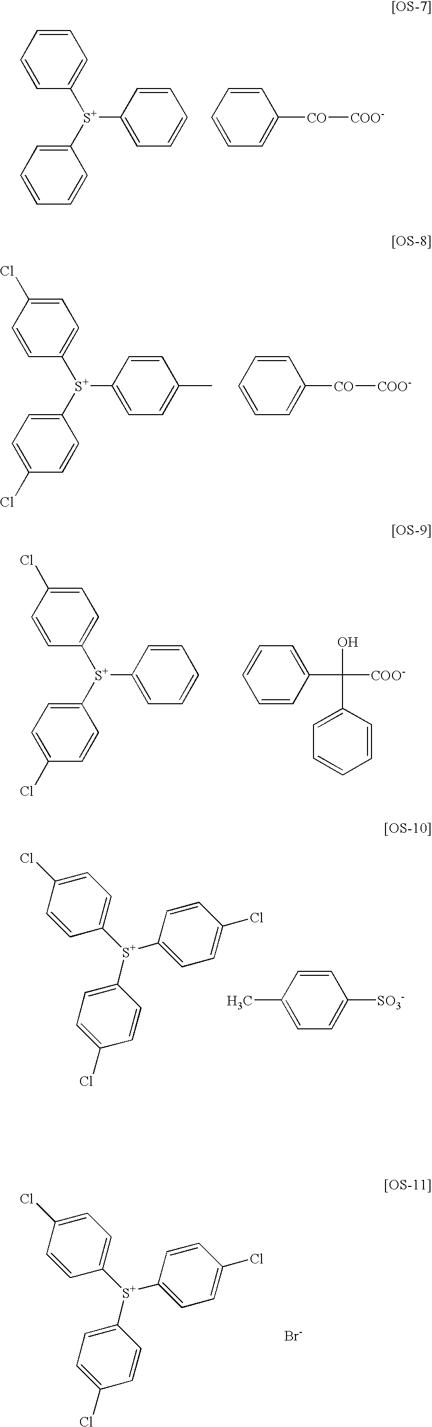

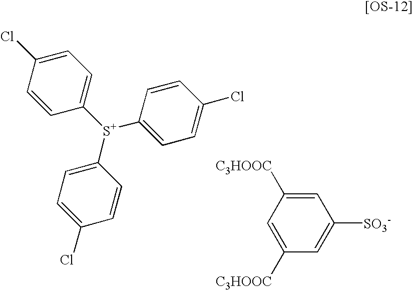

In addition to the compounds described above, specified aromatic sulfonium salts described in JP-A-2002-148790, JP-A-2002-148790, JP-A-2002-350207, and JP-A-2002-6482 can be suitably used.

In the invention, in addition to the foregoing sulfonium salt polymerization initiators, other polymerization initiators (other radical generating agents) can be used jointly.

Examples of other radical generating agents include onium salts other than sulfonium salts, triazine compounds having a trihalomethyl group, peroxides, azo based polymerization initiators, azide compounds, quinonediazide compounds, oxime ester compounds, and triarylmonoalkyl borate compounds.

Examples of other onium salts that can be suitably used in the invention include iodonium salts and diazonium salts. In the invention, these onium salts function as a radical polymerization initiator but not as an acid generating agent.

As other onium salts in the invention, onium salts represented by the following formulae (II) and (III) are enumerated.
Ar²¹—I⁺—Ar²² z²¹ Formula (II)
Ar³¹—N⁺≡Z³¹⁻

In the formula (II), Ar²¹ and Ar²² each independently represents an optionally substituted aryl group having not more than 20 carbon atoms. In the case where the aryl group has a substituent, examples of preferred substituents include a halogen atom, a nitro group, an alkyl group having not more than 12 carbon atoms, an alkoxy group having not more than 12 carbon atoms, and an aryloxy group having not more than 12 carbon atoms. Z²¹⁻ represents a counter ion synonymous with Z¹¹⁻.

In the formula (III), Ar³¹ represents an optionally substituted aryl group having not more than 20 carbon atoms. Examples of preferred substituents include a halogen atom, a nitro group, an alkyl group having not more than 12 carbon atoms, an alkoxy group having not more than 12 carbon atoms, an aryloxy group having not more than 12 carbon atoms, an alkylamino group having not more than 12 carbon atoms, a dialkylamino group having not more than 12 carbon atoms, an arylamino group having not more than 12 carbon atoms, and a diarylamino group having not more than 12 carbon atoms. Z³¹⁻ represents a counter ion synonymous with Z¹¹⁻.

Specific examples of the onium salt represented by the formula (II) that can be suitably used in the invention ([OI-1] to [OI-10]) and specific examples of the onium salt represented by the formula (III) that can be suitably used in the invention ([ON-1] to [ON-5]) will be given below, but it should not be construed that the invention is limited thereto.

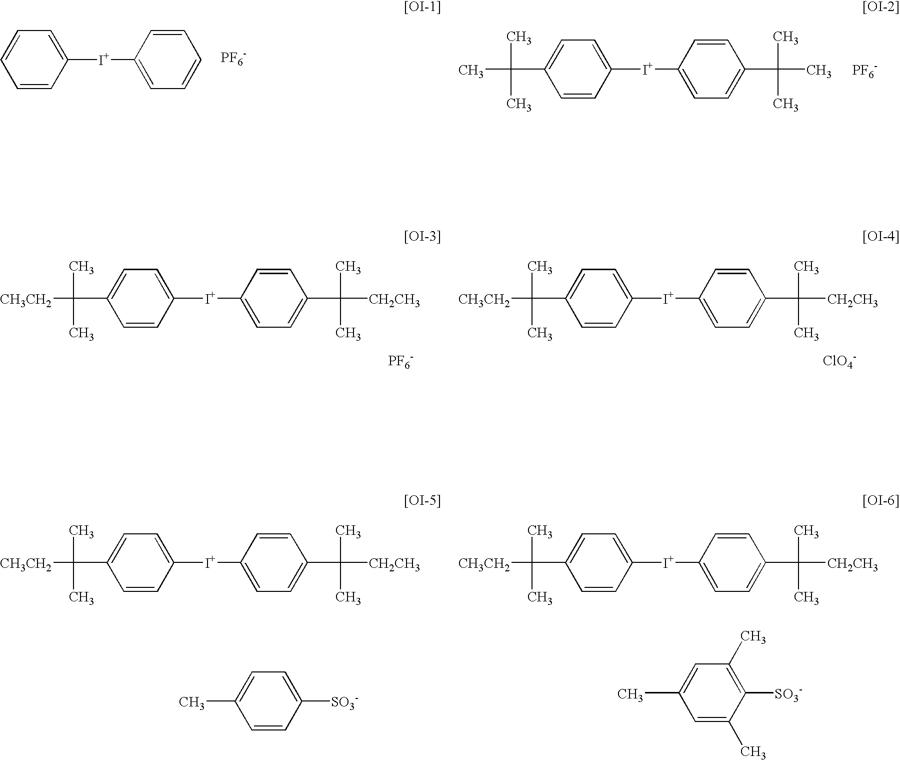

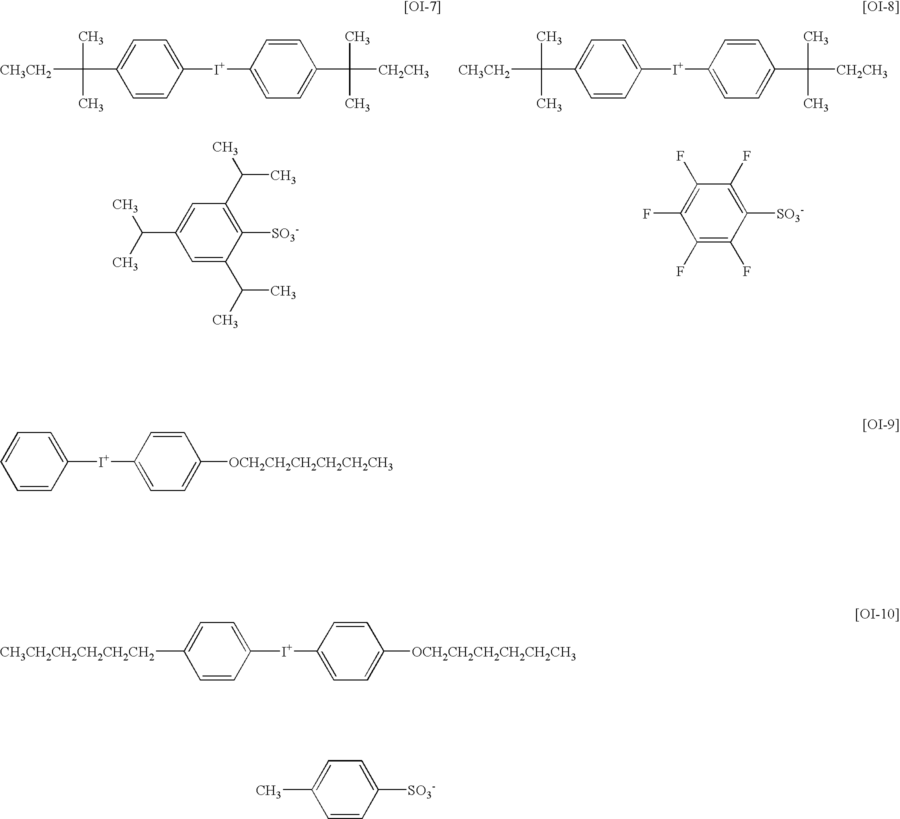

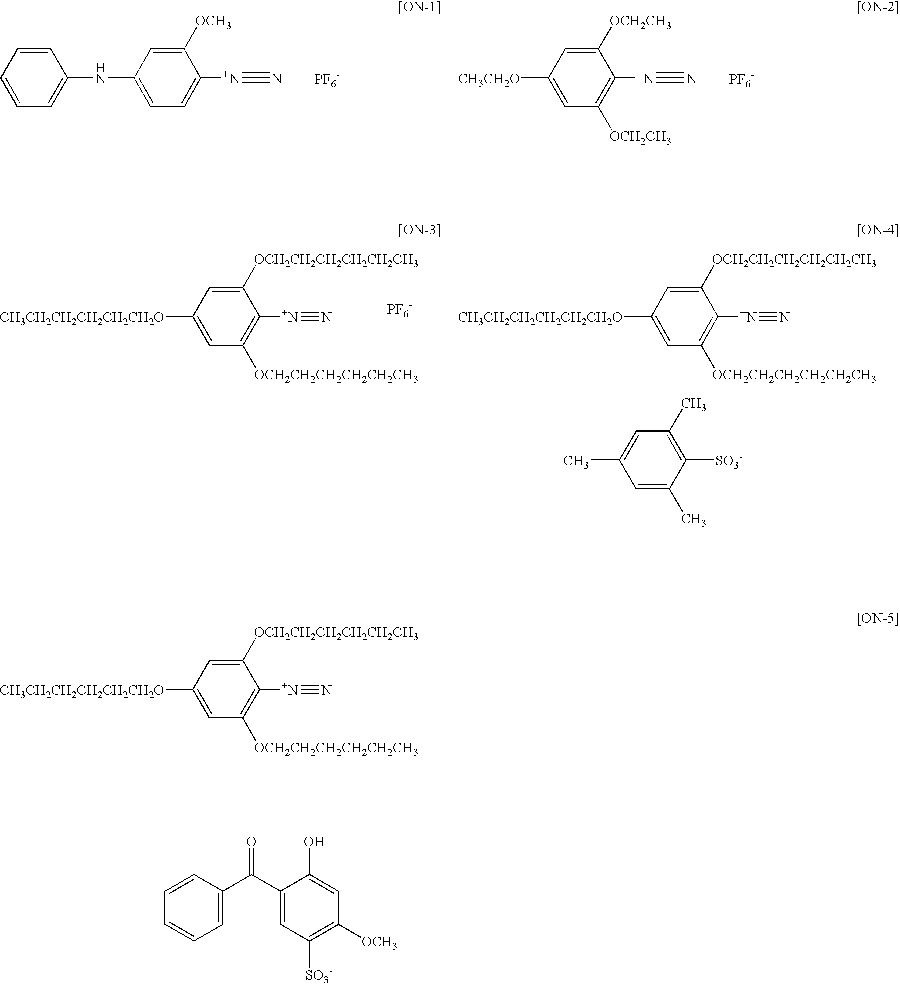

Specific examples of the onium salt that can be suitably used as the polymerization initiator (radical generating agent) in the invention include ones described in JP-A-2001-133696.

Incidentally, the polymerization initiator (radical generating agent) to be used in the invention preferably has a maximum absorption wavelength of not more than 400 nm, and more preferably not more than 360 nm. By adjusting the absorption wavelength within the ultraviolet region in this way, handling of the lithographic printing plate precursor can be carried out under a white lamp.

In the invention, the total content of the polymerization initiator is from 0.1 to 50% by weight, preferably from 0.5 to 30% by weight, and especially preferably from 1 to 20% by weight based on the whole of solids constituting the photosensitive layer from the viewpoints of sensitivity and generation of stains in non-image areas at the time of printing.

In the invention, though it is preferable that the polymerization initiator contains a sulfonium salt polymerization initiator as an essential component, it may be used singly or in admixture of two or more thereof. In the case where two or more of polymerization initiators are used, a plural kind of sulfonium salt polymerization initiators only may be used, or a combination of a sulfonium salt polymerization initiator with other polymerization initiator may be used.

In the case where the sulfonium salt polymerization initiator is used in combination with other polymerization initiator, the content ratio (weight ratio) is preferably from 100/1 to 100/50, and more preferably from 100/5 to 100/25.

Also, the polymerization initiator may be added in the same layer containing other components, or may be added to a layer to be provided separately.

In the invention, in the case where a high-speed sulfonium salt polymerization initiator is used in the photosensitive layer, the radical polymerization reaction effectively advances, and the strength of formed image areas becomes very high. Also, in an embodiment wherein the lithographic printing plate precursor of the invention has a protective layer on the photosensitive layer, it is possible to prepare a lithographic printing layer having a high strength of image areas in cooperation with an oxygen-shielding function of such a protective layer. As a result, the resistance to printing is improved. Also, since the sulfonium salt polymerization initiator itself has excellent stability with time, in storing the prepared lithographic printing plate precursor, it is possible to inhibit the generation of undesired polymerization reaction.

(Polymerizable Compound)

The polymerizable compound that is used in the photosensitive layer of the lithographic printing plate precursor of the invention is an addition polymerizable compound containing at least one ethylenically unsaturated double bond and is selected from compounds containing at least one, and preferably two or more ethylenically unsaturated bonds. A group of such compounds is widely known in the subject industrial field, and these compounds can be used in the invention without particular limitations. These compounds have a chemical form of, for example, a monomer or a prepolymer, that is, a diner, a trimer, and an oligomer, or a mixture or copolymer thereof. Examples of monomers and copolymers thereof include unsaturated carboxylic acids (for example, acrylic acid, methacrylic acid, itaconic acid, crotonic acid, isocrotonic acid, and maleic acid) and esters and amides thereof; and preferably esters between an unsaturated carboxylic acid and an aliphatic polyhydric alcohol compound and amides between an unsaturated carboxylic acid and an aliphatic polyhydric amine compound. Also, addition reaction products of an unsaturated carboxylic acid ester or amide containing a nucleophilic substituent (for example, a hydroxyl group, an amino group, and a mercapto group) with a monofunctional or polyfunctional isocyanate or epoxy, and dehydration condensation reaction products thereof with a monofunctional or polyfunctional carboxylic acid are suitably used. Also, addition reaction products of an unsaturated carboxylic acid ester or amide containing an electrophilic substituent (for example, an isocyanate group and an epoxy group) with a monofunctional or polyfunctional alcohol, amine or thiol, and displacement reaction products of an unsaturated carboxylic acid ester or amide containing an eliminating substituent (for example, a halogen group and a tosyloxy group) with a monofunctional or polyfunctional alcohol, amine or thiol are also suitable. Also, it is possible to use a group of compounds in which the foregoing unsaturated carboxylic acid is replaced by an unsaturated sulfonic acid, styrene, vinyl ether, etc.

Specific examples of monomers of the ester of an aliphatic polyhydric alcohol compound and an unsaturated carboxylic acid are as follows. Examples of acrylic esters include ethylene glycol diacrylate, triethylene glycol diacrylate, 1,3-butanediol diacrylate, tetramethylene glycol diacrylate, propylene glycol diacrylate, neopentyl glycol diacrylate, trimethylolpropane triacrylate, trimethyl-olpropane tri(acryloyloxypropyl) ether, trimethylolethane triacrylate, hexanediol diacrylate, 1,4-cyclohexanediol diacrylate, tetraethylene glycol diacrylate, pentaerythritol diacrylate, pentaerythritol triacrylate, pentaerythritol tetraacrylate, dipentaerythritol diacrylate, dipenta-erythritol hexaacrylate, sorbitol triacrylate, sorbitol tetraacrylate, sorbitol pentaacrylate, sorbitol hexaacrylate, tri(acryloyloxyethyl) isocyanurate, and polyester acrylate oligorners.

Examples of methacrylic esters include tetramethylene glycol dimethacrylate, triethylene glycol dimethacrylate, neopentyl glycol dimethacrylate, trimethylolpropane trimethacrylate, trimethylolethane trimethacrylate, ethylene glycol dimethacrylate, 1,3-butanediol dimethacrylate, hexanediol dimethacrylate, pentaerythritol dimethacrylate, pentaerythritol trimethacrylate, penta-erythritol tetramethacrylate, dipentaerythritol dimethacrylate, dipentaerythritol hexamethacrylate, sorbitol trimethacrylate, sorbitol tetramethacrylate, bis-[(p-(3-methacryloxy-2-hydroxypropoxy)phenyl]dimethylmethane, and bis p-(methacryloxyethoxy)phenyl]dimethylmethane.

Examples of itaconic esters include ethylene glycol diitaconate, propylene glycol diitaconate, 1,3-butanediol diitaconate, 1,4-butanediol diitaconate, tetramethylene glycol diitaconate, pentaerythritol diitaconate, and sorbitol tetraitaconate.

Examples of crotonic esters include ethylene glycol dicrotonate, tetramethylene glycol dicrotonate, penta-erythritol dicrotonate, and sorbitol tetradicrotonate.

Examples of isocrotonic esters include ethylene glycol diisocrotonate, pentaerythritol diisocrotonate, and sorbitol tetraisocrotonate.

Examples of maleic esters include ethylene glycol dimaleate, triethylene glycol dimaleate, pentaerythritol dimaleate, and sorbitol tetramaleate.

As examples of other esters, aliphatic alcohol based esters described in JP-B-46-27926, JP-B-51-47334, and JP-A-57-196231; esters having an aromatic skeleton described in JP-A-59-5240, JP-A-59-5241, and JP-A-2-226149; and esters containing an amino group described in JP-A-1-165613 are also suitably used. Further, the foregoing ester monomers can be used as a mixture.

Also, examples of monomers of the amide between an aliphatic polyhydric amine compound and an unsaturated carboxylic acid include methylenebis-acrylamide, methylenebis-methacrylamide, 1,6-hexamethylenebis-acryl amide, 1,6-hexamethylenebis-methacrylamide, diethylene-triamine trisacrylamide, xylylenebisacrylamide, and xylylenebismethacrylamide. As other preferred examples of amide based monomers, ones having a cyclobexylene structure as described in JP-B-54-21726 can be enumerated.

Also, urethane based addition polymerizable compounds produced using addition reaction between an isocyanate and a hydroxyl group are suitable. As specific examples, vinyl urethane compounds containing two or more polymerizable vinyl groups in one molecule, which are prepared by adding a hydroxyl group-containing vinyl monomer represented by the following formula (1) to a polyisocyanate compound containing two or more isocyanate groups in one molecule, as described in JP-B-48-41708, are enumerated.
CH₂═C(R₄)COOCH₂CH(R₅) OH Formula (1)

In the formula, R₄ and R₅ each represents H or CH₃.

Also, urethane acrylates described in JP-A-51-37193, JP-B-2-32293, and JP-B-2-16765; and urethane compounds having an ethylene oxide based skeleton described in JP-B-58-49860, JP-B-56-17654, JP-B-62-39417, and JP-B-62-39418 are suitable. Further, by using a polymerizable compound having an amino structure or a sulfide structure in the molecule described in JP-A-63-277653, JP-A-63-260909, and JP-A-1-105238, it is possible to obtain a polymerizable composition having very excellent photosensitive speed.

Other examples include polyester acrylates and polyfunctional acrylates or methacrylates of epoxy acrylates obtained by reacting an epoxy resin and (meth)acrylic acid, as described in JP-A-48-64183, JP-B-49-43191, and JP-B-52-30490. Also, specified unsaturated compounds described in JP-B-46-43946, JP-B-1-40337, and JP-B-1-40336; and vinyl phosphonic acid based compounds described in JP-A-2-25493 can be enumerated. Also, in some cases, compounds having a perfluoroalkyl group-containing structure described in JP-A-61-22048 are suitably used. Further, compounds introduced as photocurable monomers or oligomers in Journal of The Adhesion Society of Japan, Vol. 20, No. 7, pp 300-308 (1984) can be used.

With respect to these addition polymerizable compounds, the details of the use method including their structures, single use or combined use, and addition amount can be arbitrarily set up depending upon the ultimate performance design. For example, the selection is made from the following viewpoints. From the standpoint of photosensitive speed, a structure wherein the unsaturated group content per molecule is high is preferable, and in many cases, bifunctional or polyfunctional compounds are preferable. Also, for the sake of enhancing the strength in image areas, i.e., a cured film, trifunctional or polyfunctional compounds are preferable. Further, a method in which both of sensitivity and film strength are adjusted by jointly using compounds having a different functionality and a different polymerizable group (such as acrylic esters, methacrylic esters, styrene based compounds, and vinyl ether based compounds) is effective. Though compounds having a high molecular weight or compounds having high hydrophobicity are excellent with respect to the photosensitive speed and film strength, they may possibly be undesired from the standpoints of development speed and deposition in the developing solution. Also, with respect to the affinity with or dispersibility in other components in the recording layer (such as a binder polymer, an initiator, and a coloring agent), the selection and use methods of addition polymerizable compounds are important factors. For example, the affinity may possibly be enhanced by using a low-purity compound or jointly using two or more kinds of the compounds.

Also, in the lithographic printing plate precursor of the invention, for the purpose of enhancing adhesion to a support or an overcoat layer described later, a specified structure can be selected.

With respect to a compounding ratio of the addition polymerizable compound in the photosensitive layer composition, a high compounding ratio is advantageous from the standpoint of sensitivity. In the case where the compounding ratio is too high, undesirable phase separation may possibly occur, problems in the manufacturing step due to adhesiveness of the photosensitive layer of the lithographic printing plate precursor (for example, transfer of the photosensitive layer components and manufacturing failure derived from adhesion) may possibly be caused, and a problem such as deposition from the developing solution may possibly be caused. From these viewpoints, the addition polymerizable compound is preferably used in an amount in the range of from 5 to 80% by weight, and more preferably from 25 to 75% by weight based on non-volatile components in the photosensitive layer composition. The addition polymerizable compound may be used singly or in admixture of two or more thereof. Besides, with respect to the use method of the addition polymerizable compound, adequate structure, compounding and addition amount can be arbitrarily selected from the viewpoints of degree of polymerization inhibition against oxygen, resolution, fogging property, change in the refractive index, surface adhesiveness, etc. Further, in the lithographic printing plate precursor of the invention, a layer construction or coating method such as undercoat and overcoat can be carried out.

(Binder Polymer)

The binder polymer that is used in the photosensitive layer of the lithographic printing plate precursor of the invention is contained from the viewpoint of enhancing the film property, and various binder polymers can be used so far as they have a function to enhance the film property. Above all, in the invention, the suitable binder polymer is a binder polymer having a repeating unit represented by the foregoing formula (A).

The binder polymer having a repeating unit represented by the foregoing formula (A) will be properly called as “specified binder polymer” and described below in detail.

First of all, in the formula (A), R¹ represents a hydrogen atom or a methyl group, and especially preferably a methyl group.

In the formula (A), the connecting group represented by R² is constituted of one or more atoms selected from the group consisting of a carbon atom, a hydrogen atom, an oxygen atom, a nitrogen atom, and a sulfur atom and preferably has from 2 to 82 atoms exclusive of the substituent. Specifically, the number of atoms constituting the principal skeleton of the connecting group represented by R² is preferably from 1 to 30, more preferably from 3 to 25, further preferably from 4 to 20, and most preferably from 5 to 10. Incidentally, the term “principal skeleton of the connecting group” as referred to in the invention means an atom or an atomic group to be used only for the purpose of connecting A to the terminal COOH in the formula (A). In particular, in the case where plural connecting routes are present, it means an atom or an atomic group constituting a route having the smallest number of atoms to be used. Accordingly, in the case where a ring structure is contained within the connecting group, the number of atoms to be counted therein from the connecting site (for example, o-, m-, and p-) differs.

Also, more specifically, the connecting group includes an alkylene, a substituted alkylene, an arylene, and a substituted arylene and may have a structure wherein the plural number of such divalent groups are connected via an amide linkage or an ester linkage.

Examples of the connecting group having a chain structure include ethylene and propylene. Also, these alkylenes may be connected to each other via an ester linkage.

Above all, in the formula (A), it is preferable that the connecting group represented by R² is a hydrocarbon group having a valence of (n+1) and having an aliphatic ring structure having from 3 to 30 carbon atoms. More specifically, a hydrocarbon group having a valence of (n+1) eliminating (n+1) hydrogen atoms on arbitrary carbon atoms constituting a compound having an aliphatic ring structure such as cyclopropane, cyclopentane, cyclohexane, cycloheptane, cyclooctane, cyclodecane, dicyclohexyl, tercyclohexyl, and notbornane can be enumerated. Also, it is preferable that R² has from 3 to 30 carbon atoms including a substituent.

One or more arbitrary carbon atoms of a compound constituting an aliphatic ring structure may be substituted with a hetero atom selected from a nitrogen atom, an oxygen atom, and a sulfur atom. It is preferable in view of the resistance to printing that R² is an optionally substituted hydrocarbon group having a valence of (n+1) and having an aliphatic ring structure having from 5 to 30 carbon atoms, which contains two or more rings, such as fused polycyclic aliphatic hydrocarbons, crosslinked cyclic aliphatic hydrocarbons, Spiro aliphatic hydrocarbons, and aliphatic hydrocarbon ring agglomerates (ones in which plural rings are bonded to each other or via a connecting group). In this case, the number of carbon atoms is one including carbon atoms of the substituent or substituents.

The connecting group represented by R² is especially preferably one in which the number of atoms constituting the principal skeleton of the connecting group is from 5 to 10. From the standpoint of the structure, chain structures in which an ester linkage is contained in the structure, or ones having a ring structure as described previously are preferable.

As the substituent that can be introduced into the connecting group represented by R², a monovalent non-metallic atomic group exclusive of hydrogen can be enumerated. Examples thereof include a halogen atom (for example, —F, —Br, —Cl, and —I), a hydroxyl group, an alkoxy group, an aryloxy group, a mercapto group, an alkylthio group, an arylthio group, an alkyldithio group, an aryldithio group, an amino group, an N-alkylamino group, an N,N-dialkylamino group, an N-arylamino group, an N,N-diarylamino group, an N-alkyl-N-arylamino group, an acyloxy group, a carbamoyloxy group, an N-alkylcarbamoyl-oxy group, an N-arylcarbamoyloxy group, an N,N-dialkyl-carbamoyloxy group, an N,N-diarylcarbamoyloxy group, an N-alkyl-N-arylcarbamoyloxy group, an alkylsulfoxy group, an arylsulfoxy group, an acylthio group, an acylamino group, an N-alkylacylamino group, an N-arylacylamino group, a ureido group, an N′-alkylureido group, an N′,N′-dialkylureido group, an N′-arylureido group, an N′,N′-diarylureido group, an N′-alkyl-N′-arylureido group, an N-alkylureido group, an N-arylureido group, an N′-alkyl-N-alkylureido group, an N′-alkyl-N-arylureido group, an N′,N′-dialkyl-N-alkylureido group, an N′,N′-dialkyl-N-arylureido group, an N′-aryl-N-alkylureido group, an N′-aryl-N-arylureido group, an N′,N′-diaryl-N-alkylureido group, an N′,N′-diaryl-N-arylureido group, an N′-alkyl-N′-aryl-N-alkylureido group, an N′-al-kyl-N′-aryl-N-arylureido group, an alkoxycarbonylamino group, an aryloxycarbonylamino group, an N-alkyl-N-alkoxy-carbonylamino group, an N-alkyl-N-aryloxycarbonylamino group, an N-aryl-N-alkoxycarbonylamino group, an N-aryl-N-aryl-oxycarbonylamino group, a formyl group, an acyl group, a carboxyl group and a conjugated base group thereof, an alkoxycarbonyl group, an aryloxycarbonyl group, a carbamoyl group, an N-alkylcarbamoyl group, an N,N-dialkylcarbamoyl group, an N-arylcarbamoyl group, an N,N-diarylcarbamoyl group, an N-alkyl-N-arylcarbamoyl group, an alkylsulfinyl group, an arylsulfinyl group, an alkylsulfonyl group, an arylsulfonyl group, a sulfo group (—SO₃H) and a conjugated base group thereof, an alkoxysulfonyl group, an aryloxysulfonyl group, a sulfinamoyl group, an N-alkylsulfinamoyl group, an N,N-dialkylsulfinamoyl group, an N-arylsulfinamoyl group, an N,N-diarylsulfinamoyl group, an N-alkyl-N-arylsulfinamoyl group, a sulfamoyl group, an N-alkylsulfamoyl group, an N,N-dialkylsulfamoyl group, an N-arylsulfamoyl group, an N,N-diarylsulfamoyl group, an N-alkyl-N-arylsulfamoyl group, an N-acylsulfamoyl group and a conjugated base group thereof, an N-alkylsulfonylsulfamoyl group (—SO₂NHSO₂(alkyl)) and a conjugated base group thereof, an N-arylsulfonylsulfamoyl group (—SO₂NHSO₂(aryl)) and a conjugated base group thereof, an N-alkylsulfonylcarbamoyl group (—CONHSO₂(alkyl)) and a conjugated base group thereof, an N-arylsulfonylcarbamoyl group (—CONHSO₂(aryl)) and a conjugated base group thereof, an alkoxysilyl group (—Si(O-alkyl)₃), an aryloxysilyl group (—Si(O-aryl)₃), a hydroxysilyl group (Si(OH)₃) and a conjugated base group thereof, a phosphono group (—PO₃H₂) and a conjugated base group thereof, a dialkylphosphono group (—PO₃(alkyl)₂), a diarylphosphono group (—PO₃(aryl)₂), an alkylarylphosphono group (—PO₃(alkyl)(aryl)), a monoalkyl-phosphono group (—PO₃H(alkyl)) and a conjugated base group thereof, a monoarylphosphono group (—PO₃H(aryl)) and a conjugated base group thereof, a phosphonooxy group (—OPO₃H₂) and a conjugated base group thereof, a dialkylphosphonooxy group (—OPO₃(alkyl)₂), a diarylphosphonooxy group (—OPO₃-(aryl) 2), an alkylarylphosphonooxy group (—OPO₃—(alkyl) (aryl)), a monoalkylphosphonooxy group (—OPO₃H(alkyl)) and a conjugated base group thereof, a monoarylphosphonooxy group (—OPO₃H(aryl)) and a conjugated base group thereof, a cyano group, a nitro group, a dialkylboryl group (—B(alkyl)₂), a diarylboryl group (—B(aryl)₂), an alkylarylboryl group (—B(alkyl)(aryl)), a dihydroxyboryl group (—B(OH)₂) and a conjugated base group thereof, an alkylhydroxyboryl group (—B(alkyl) (OH)) and a conjugated base group thereof, an arylhydroxyboryl group (—B(aryl) (OH)) and a conjugated base group thereof, an aryl group, a an alkenyl group, and an alkynyl group.

In the lithographic printing plate precursor of the invention, depending upon the design of the photosensitive layer, hydrogen atom-containing substituents capable of undegoing hydrogen bond, especially acidic substituents having an acid dissociation constant (pKa) smaller than carboxylic acids, are not preferable because they tend to lower the resistance to printing. On the other hand, hydrophobic substituents such as halogen atoms, hydrocarbon groups (for example, an alkyl group, an aryl group, an alkenyl group, and an alkynyl group), alkoxy groups, and aryloxy groups are more preferable because they tend to enhance the resistance to printing. In particular, in the case where the ring structure is a monocyclic aliphatic hydrocarbon having not more than 6 members, such as cyclopentane and cyclohexane, it is preferable that such a hydrophobic substituent is contained. If possible, such a substituent may be bonded to another substituent or a substituted hydrocarbon group to form a ring, or may be further substituted.

In the formula (A), in the case where A is NR³—, R³ represents a hydrogen atom or a monovalent hydrocarbon group having from 1 to 10 carbon atoms. Examples of the monovalent hydrocarbon group having from 1 to 10 carbon atoms as represented by R³ include an alkyl group, an aryl group, an alkenyl group, and an alkynyl group.

Specific examples of the alkyl group include linear, branched or cyclic alkyl group having from 1 to 10 carbon atoms such as a methyl group, an ethyl group, a propyl group, a butyl group, a pentyl group, a hexyl group, a heptyl group, an octyl group, a nonyl group, a decyl group, an isopropyl group, an isobutyl group, a sec-butyl group, a tert-butyl group, an isopentyl group, a neopentyl group, a 1-methylbutyl group, an isohexyl group, a 2-ethylhexyl group, a 2-methylhexyl group, a cyclopentyl group, a cyclohexyl group, a 1-adamantyl group, and a 2-norbornyl group.

Specific examples of the aryl group include aryl groups having from 1 to 10 carbon atoms such as a phenyl group, a naphthyl group, and an indenyl group; and heteroaryl groups having from 1 to 10 carbon atoms and having one hetero atom selected from the group consisting of a nitrogen atom, an oxygen atom, and a sulfur atom, such as a furyl group, a thienyl group, a pyrrolyl group, a pyridyl group, and a quinolyl group.

Specific examples of the alkenyl group include linear, branched or cyclic alkenyl group having from 1 to 10 carbon atoms such as a vinyl group, a 1-propenyl group, a 1-butenyl group, a 1-methyl-1-propenyl group, a 1-cyclopentenyl group, and a 1-cyclohexenyl group.

Specific examples of the alkynyl group include alkynyl groups having from 1 to 10 carbon atoms such as an ethynyl group, a 1-propynyl group, a 1-butynyl group, and a 1-octynyl group. As the substituent which R₃ may have, the same substituents which R² can introduce are enumerated. However, the number of carbon atoms of R³ is from 1 to 10 including the number of carbon atoms of the substituent.

In the formula (A), it is preferable that A is an oxygen atom or —NH— because the synthesis is easy.

In the formula (A), n represents an integer of from 1 to 5, and preferably 1 in view of the resistance to printing.

Preferred specific examples of the repeating unit represented by the formula (A) will be given below, but it should not be construed that the invention is limited thereto.

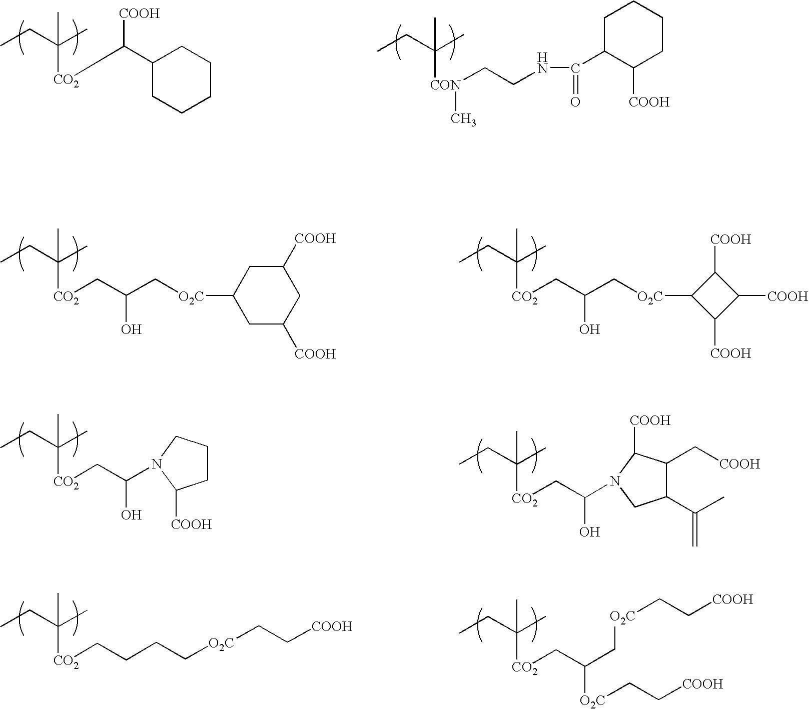

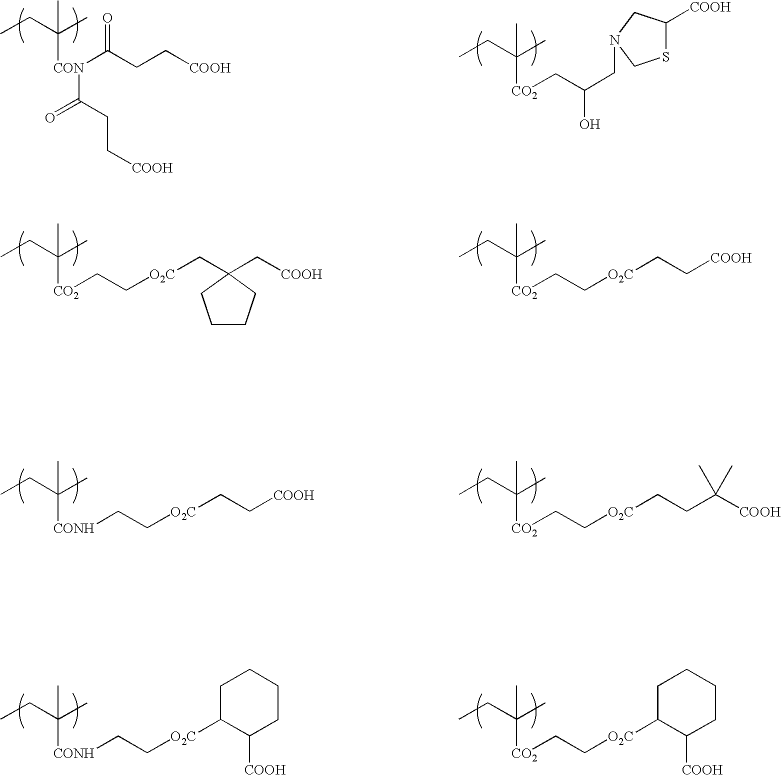

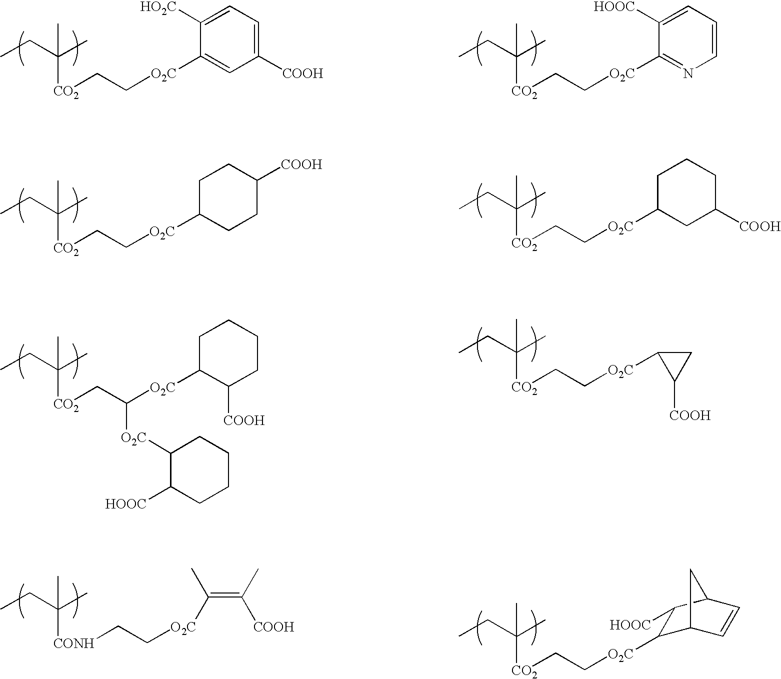

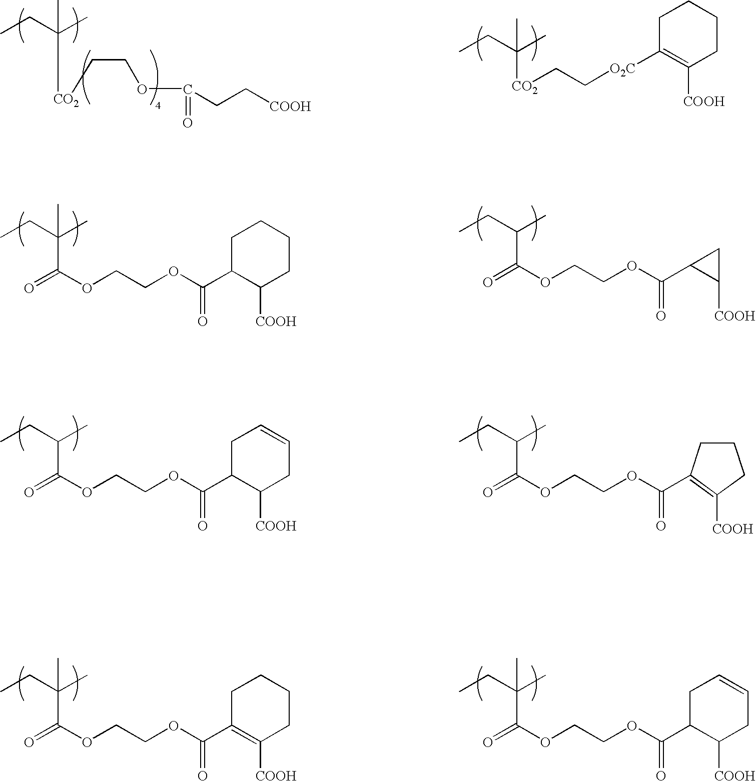

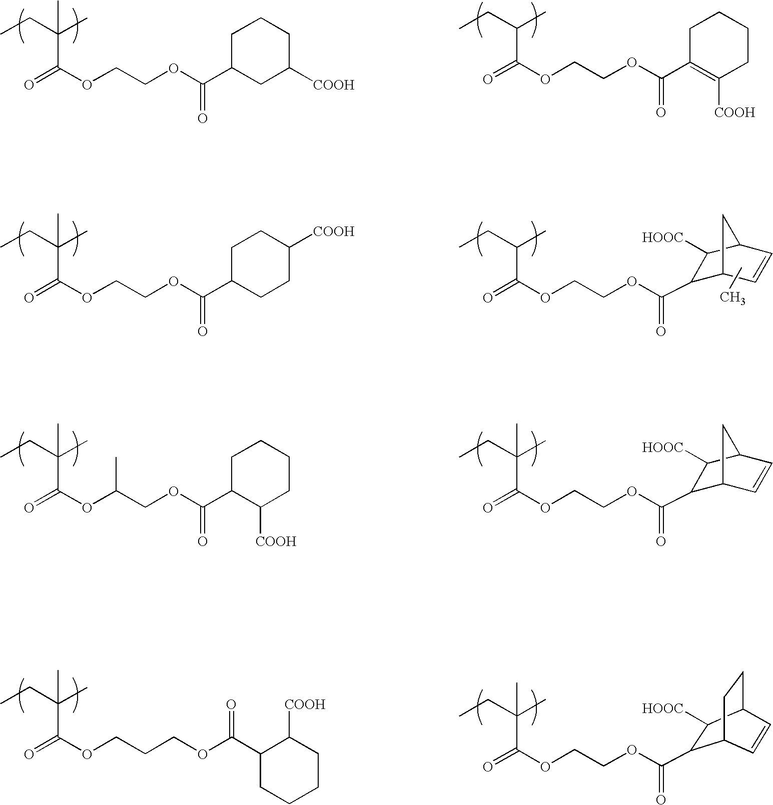

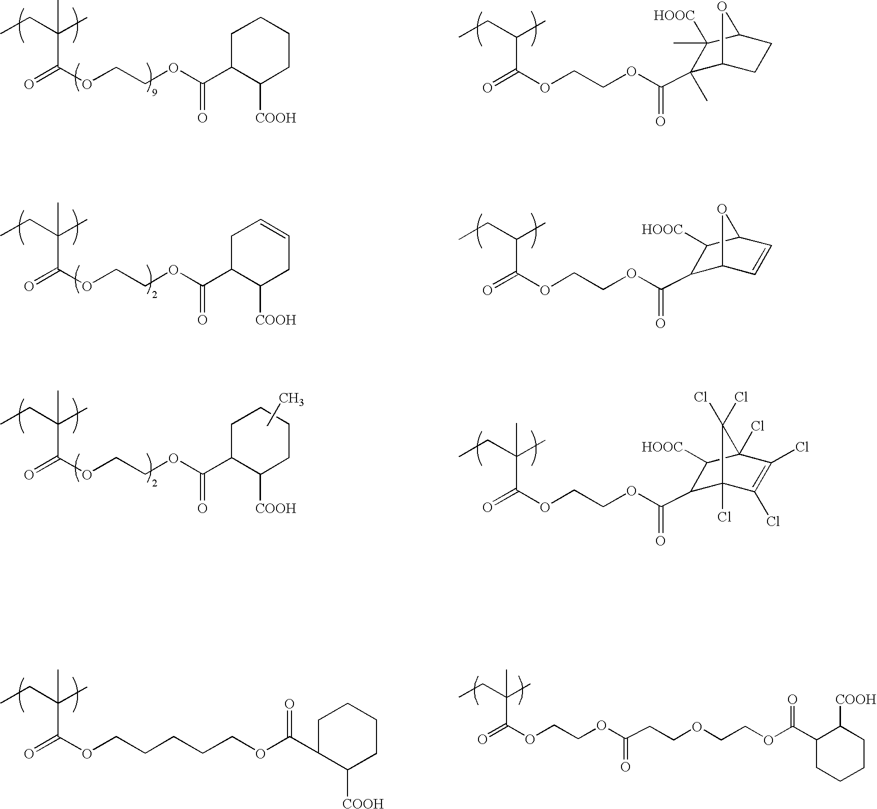

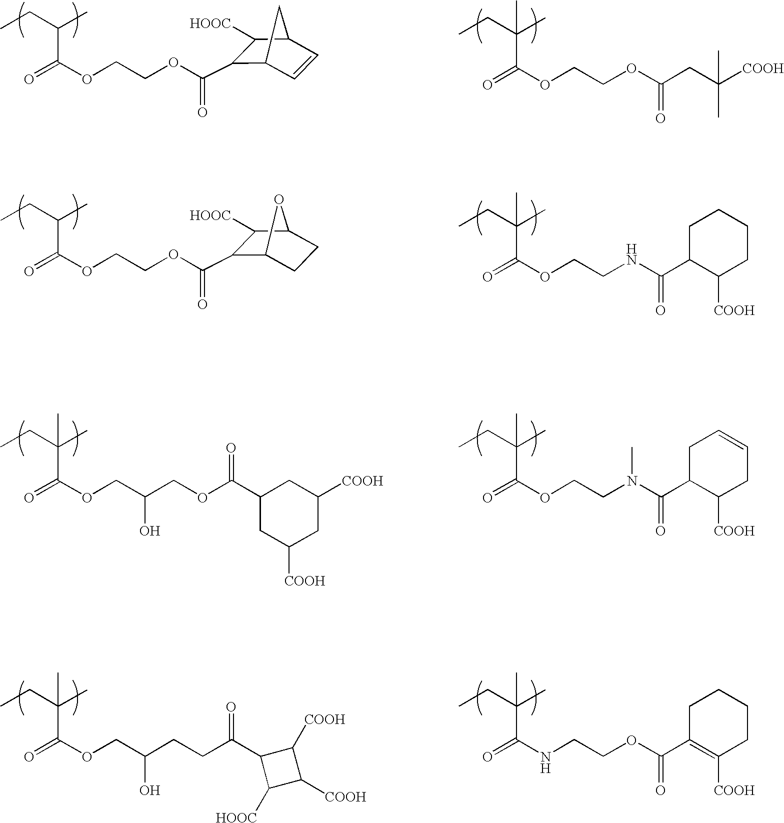

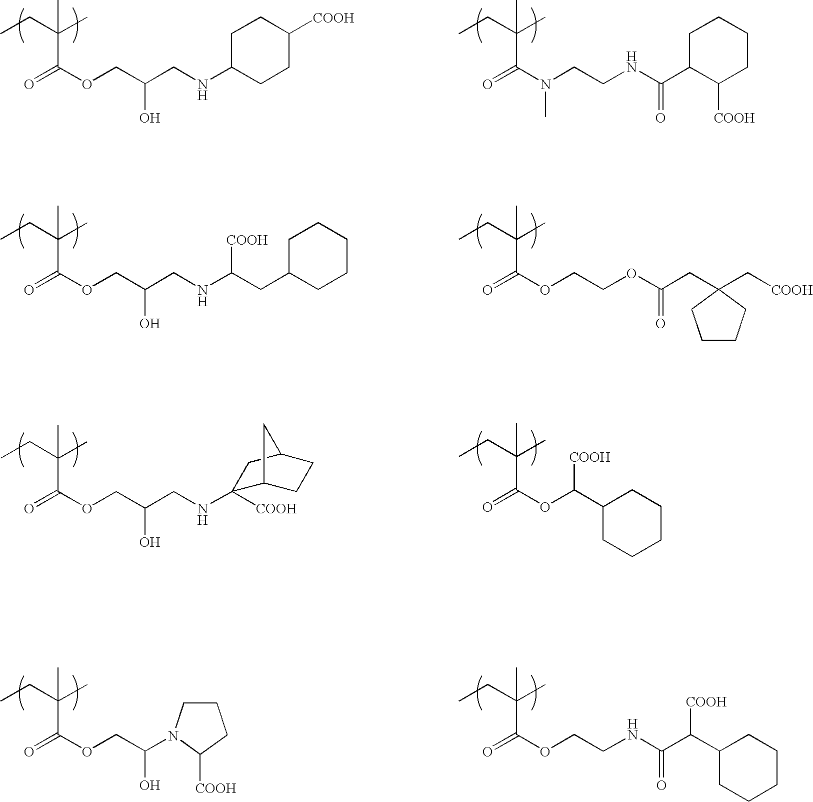

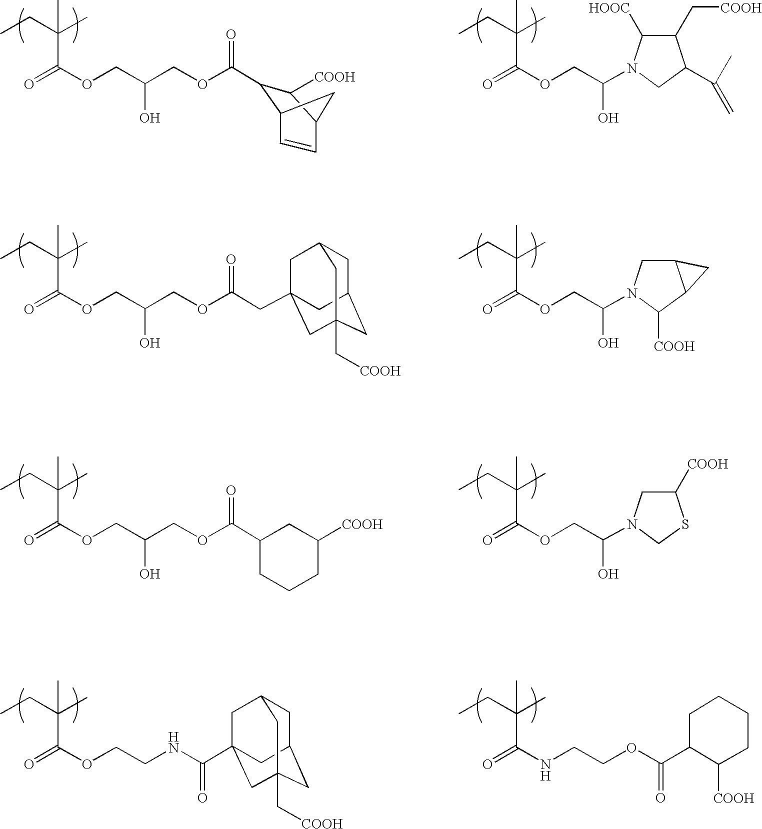

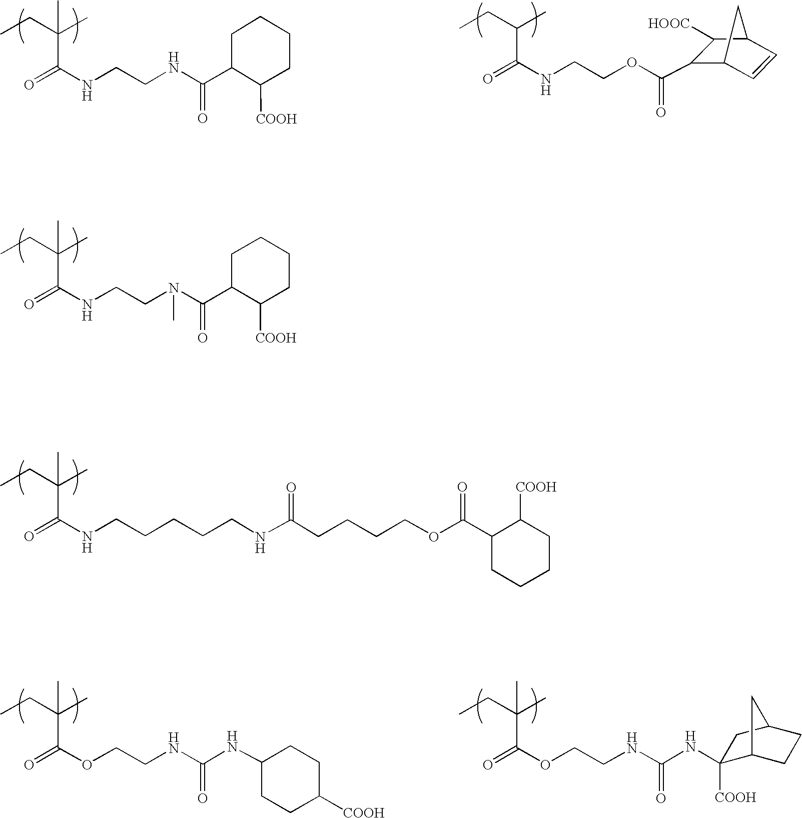

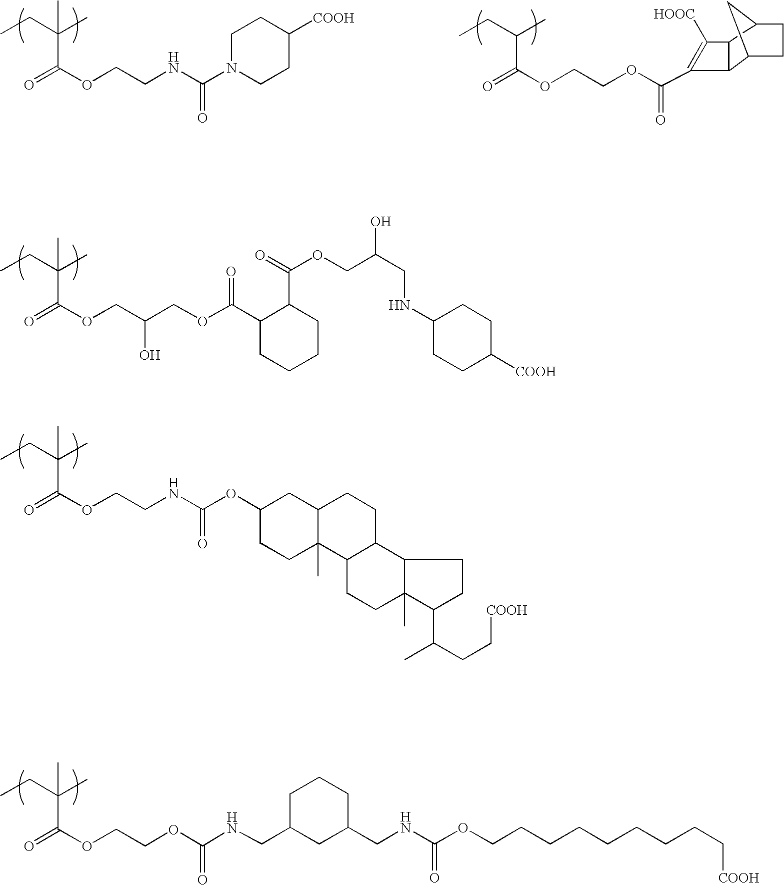

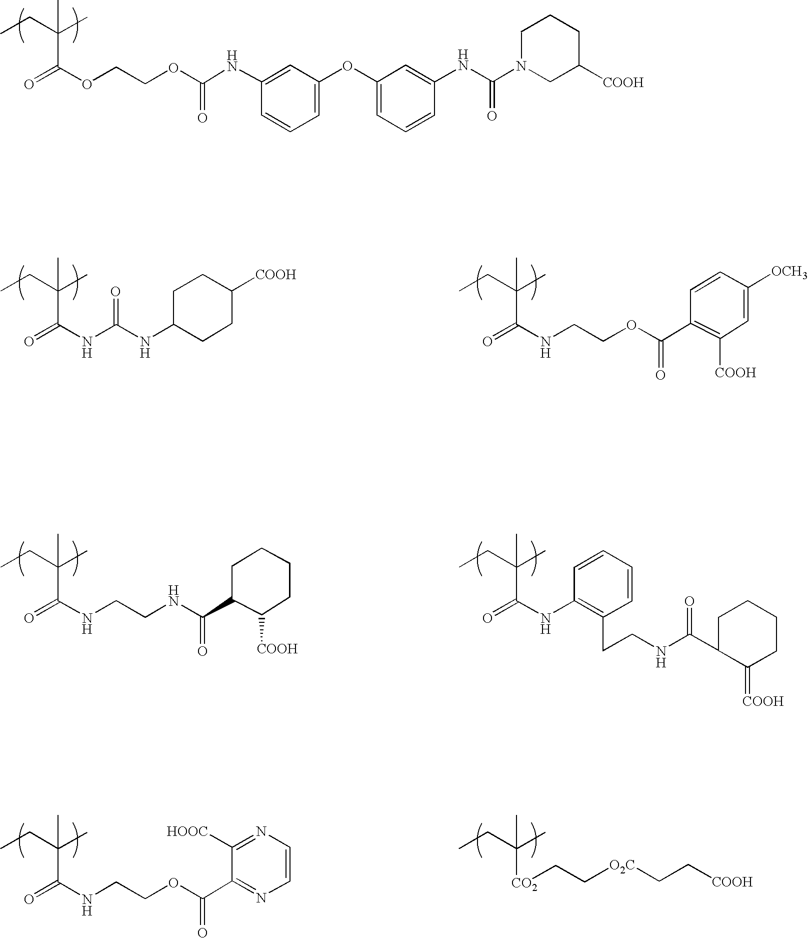

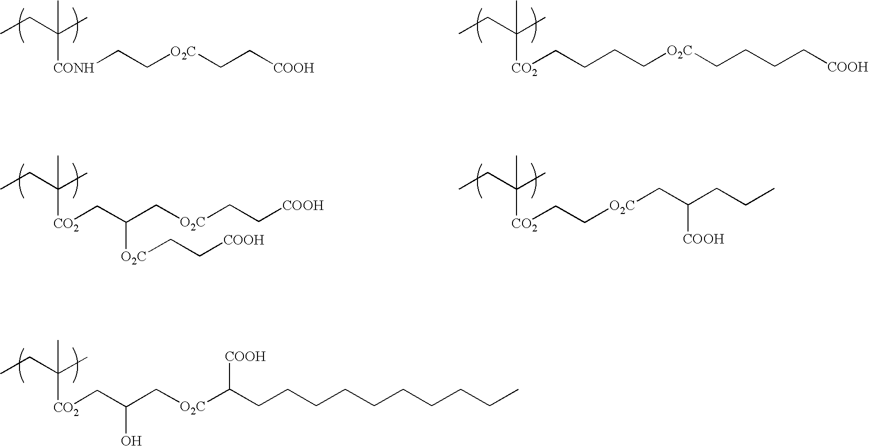

The repeating unit represented by the formula (A) may be contained singly or in admixture of two or more thereof in the binder polymer. Though the binder polymer specified in the invention may be a polymer consisting of only the repeating unit represented by the formula (A), it is in general combined with other copolymerization component and used as a copolymer. The total content of the repeating unit represented by the formula (A) in the copolymer is adequately determined depending upon its structure, the design of the photosensitive layer composition, and so no. The repeating unit represented by the formula (A) is preferably contained in an amount in the range of from 1 to 99% by mole, more preferably from 5 to 40% by mole, and further preferably from 5 to 20% by mole based on the total molar amount of the polymer components.

As the copolymerization component to be used as a copolymer, conventionally known monomers can be used without limitations so far as they are radical polymerizable. Specifically, monomers described in Polymer Data Handbook: Basic Volume (compiled by The Society of Polymer Science, Japan and published by Baifukan Co., Ltd., 1986) can be enumerated. Such a copolymerization component may be used singly or in combinations of two or more thereof.

In the invention, the molecular weight of the specified binder polymer is adequately determined from the viewpoint of the image forming property or resistance to printing. The molecular weight is preferably in the range of from 2,000 to 1,000,000, more preferably from 5,000 to 500,000, and further preferably from 10,000 to 200,000.

The binder polymer to be used in the invention is the specified binder polymer singly, or at least one other binder polymer may be used jointly as a mixture. The binder polymer that is used jointly is used in an amount in the range of from 1 to 60% by weight, preferably from 1 to 40% by weight, and further preferably from 1 to 20% by weight based on the total weight of the binder polymer component. As the binder polymer that can be used jointly, conventionally known binder polymers can be used without limitations. Specifically, acrylic principal chain binders and urethane binders, which are often used in the art, are-preferably used.

In the photosensitive layer composition, the total amount of the specified binder polymer and a binder polymer that may be used jointly can be adequately determined and is usually in the range of from 10 to 90% by weight, preferably from 20 to 80% by weight, and further preferably from 30 to 70% by weight based on the total weight of non-volatile components in the photosensitive layer composition.

Also, it is preferable that such a bonder polymer has an acid value (meg/g) in the range of from 2.00 to 3.60.

(Other Binder Polymer that can be used Jointly)

It is preferable that other binder polymer that can be used jointly with the foregoing specified binder polymer is a binder polymer having a radical polymerizable group. The radical polymerizable group is not particularly limited so far as it can be polymerized by a radical, and preferred examples thereof include an α-substituted methylacryl group [—OC(═O)—C(—CH₂Z)=CH₂, wherein Z represents a hydrocarbon group starting from a hetero atom], an acryl group, a methacryl group, an allyl group, and a styryl group. Of these, an acryl group and a methacryl group are preferable.

The content of the radical polymerizable group in such a binder polymer (content of a radical polymerizable unsaturated double bond by the titration with iodine) is preferably from 0.1 to 10.0 mmoles, more preferably from 1.0 to 7.0 nmoles, and most preferably from 2.0 to 5.5 mmoles per gram of the binder polymer from the viewpoints of sensitivity and storage stability.

Also, it is preferable that other binder polymer that can be used jointly further has an alkali-soluble group. The content of the alkali-soluble group in the binder polymer (acid value by the neutralization titration) is preferably from 0.1 to 3.0 mmoles, more preferably from 0.2 to 2.0 mmoles, and most preferably from 0.45 to 1.0 mmoles per gram of the binder polymer from the viewpoints of deposition property of development scum and resistance to printing.

The weight average molecular weight of such a binder polymer is preferably in the range of from 2,000 to 1, 000° 000, more preferably from 10,000 to 300,000, and most preferably from 20,000 to 200,000 from the viewpoints of film property (resistance to printing) and solubility in a coating solvent.

Also, the glass transition point (Tg) of such a binder polymer is preferably in the range of from 70 to 300° C., more preferably from 80 to 250° C., and most preferably from 90 to 200° C. from the viewpoints of storage stability, resistance to printing and sensitivity.

As measures for enhancing the glass transition point of the binder polymer, it is preferable that an amide group or an imido group is contained in the molecule thereof. It is especially preferable that a methacrylamide derivative is contained.

In addition to the foregoing basic components, other components can be adequately added to the photosensitive layer of the lithographic printing plate precursor of the invention depending upon the utility and production process, etc. Preferred additives will be enumerated below.

(Polymerization Inhibitor)

In the photosensitive layer of the lithographic printing plate precursor of the invention, it is desired to add a small amount of a heat polymerization inhibitor for the purpose of inhibiting unnecessary heat polymerization of a polymerizable ethylenically unsaturated double bond-containing compound, i.e., a polymerizable compound. Examples of suitable heat polymerization inhibitors include hydroquinone, p-methoxy-phenol, di-t-butyl-p-cresol, pyrogallol, t-butyl catechol, benzoquinone, 4,4′-thiobis(3-methyl-6-t-butylphenol), 2,2′-methylenebis(4-methyl-6-t-butylphenol), and N-nitro-sophenylhydroxylamine cerium(III) salt. The addition amount of the heat polymerization inhibitor is preferably from about 0.01% by weight to about 5% by weight based on the weight of non-volatile components in the photosensitive layer composition. Also, if desired, for the purpose of preventing the polymerization inhibition by oxygen, a higher fatty acid derivative such as behenic acid and behenic amide may be added and unevenly distributed in the surface of the layer during the step of drying after coating. The addition amount of the higher fatty acid derivative is preferably from about 0.5% by weight to about 10% by weight based on non-volatile components in the photosensitive layer composition.

(Coloring Agent)

Further, a dye or a pigment may be added in the photosensitive layer of the lithographic printing plate precursor of the invention for the purpose of coloration. In this way, it is possible to enhance so-called plate inspection properties including visibility as a printing plate after plate making and adaptivity for an image density measurement instrument. With respect to a coloring agent, since many dyes cause a lowering of the sensitivity of a photopolymerization type photosensitive layer, the use of a pigment as the coloring agent is especially preferable. Specific examples thereof include pigments such as phthalocyanine based pigments, azo based pigments, carbon black, and titanium oxide; and dyes such as Ethyl Violet, Crystal Violet, azo based dyes, anthraquinone based dyes, and cyanine based dyes. The addition amount of the dye or pigment as the coloring agent is preferably from about 0.5% by weight to about 5% by weight based on non-volatile components in the whole of the photosensitive layer composition.

(Other Additives)

Further, known additives such as inorganic fillers for the purpose of improving the physical properties of a cured film, other plasticizers, and sensitizing agents capable of enhancing the ink receptivity on the surface of the photosensitive layer may be added in the photosensitive layer of the lithographic printing plate precursor of the invention. Examples of plasticizers include dioctyl phthalate, didodecyl phthalate, triethylene glycol dicaprilate, dimethyl glycol phthalate, tricresyl phosphate, dioctyl adipate, dibutyl sebacate, and triacetyl glycerin. The plasticizer can be generally added in an amount in the range of not more than 10% by weight based on the total weight of the binder polymer and the addition polymerizable compound.

Also, in the photosensitive layer of the lithographic printing plate precursor of the invention, UV initiators and heat crosslinking agents can be added for strengthening the effects of heating and exposure after the development for the purpose of enhancing the film strength (resistance to printing) as described later.

Preparation of Lithographic Printing Plate

The lithographic printing plate precursor of the invention is a lithographic printing plate precursor prepared by successively providing the foregoing undercoat layer and photosensitive layer on a support and if desired, further providing a protective layer on the photosensitive layer. Such a lithographic printing plate precursor can be produced by dissolving the foregoing coating solution for undercoat layer and coating solution for photosensitive layer, each containing various components, in adequate solvents, respectively and coating the resulting solutions on a support having a specified surface shape.

In coating and providing the foregoing photosensitive layer, a polymerizable composition made of the foregoing photosensitive layer components is dissolved in a variety of organic solvents and coated on the undercoat layer.

Examples of solvents that can be used include acetone, methyl ethyl ketone, cyclohexane, ethyl acetate, ethylene dichloride, tetrahydrofuran, toluene, ethylene glycol monomethyl ether, ethylene glycol mohoethyl ether, ethylene glycol dimethyl ether, propylene glycol monomethyl ether, propylene glycol monoethyl ether, acetylacetone, cyclo-hexanone, diacetone alcohol, ethylene glycol monomethyl ether acetate, ethylene glycol ethyl ether acetate, ethylene glycol monoisopropyl ether, ethylene glycol monobutyl ether acetate, 3-methoxypropanol, methoxymethoxyethanol, diethylene glycol monomethyl ether, diethylene glycol monoethyl ether, diethylene glycol dimethyl ether, diethylene glycol diethyl ether, propylene glycol monomethyl ether acetate, propylene glycol monoethyl ether acetate, 3-methoxypropyl acetate, N,N-dimethylform mide, dimethyl sulfoxide, γ-butyrolatone, methyl lactate, and ethyl lactate. These solvents can be used singly or in admixture. The concentration of solids in the coating solution is properly from 2 to 50% by weight.

The coating amount of the foregoing photosensitive layer can affect chiefly the sensitivity and developability of the photosensitive layer and the strength and resistance to printing of the exposed film, and therefore, it is desired that the coating amount of the photosensitive layer is adequately chosen depending upon the application. In the case where the coating amount is too small, the resistance to printing is not satisfactory. On the other hand, in the case where it is too large, not only the sensitivity decreases so that it takes a time to achieve the exposure, but also the development treatment requires a longer period of time, and hence, such is not preferable. As a lithographic printing plate precursor for scanning exposure as the principal object of the invention, the coating amount is preferably in the range of from about 0.1 g/m² to about 10 g/m², and more preferably from 0.5 to 5 g/m² in terms of the weight after drying.

(Physical Properties of Photosensitive Layer)

Incidentally, with respect to physical properties of the photosensitive layer in the lithographic printing plate precursor of the invention, it is preferable that the development rate of unexposed areas is 80 nm/sec or more against an alkaline developing solution having a pH of from 10 to 13.5 and that the penetration rate in exposed areas of the alkaline developing solution is not more than 100 nF/sec.

Incidentally, the development rate by an alkaline developing solution having a pH of from 10 to 13.5 as referred to herein is a value obtained by dividing the film thickness (m) by the time required for the development (sec); and the penetration rate of the alkaline developing solution as referred to herein is a value showing a change rate of the electrostatic capacity (F) in the case where the foregoing photosensitive layer is subjected to film formation on a conductive support and dipped in the developing solution.

The measurement methods of the “development rate against the alkaline developing solution” and the “penetration rate of the alkaline developing solution” will be described below in detail.

[Measurement of Development rate against the Alkaline Developing Solution]

Here, the development rate of the photosensitive layer against the alkaline developing solution is a value obtained by dividing the film thickness (m) of the photosensitive layer by the time required for the development (sec).

In the invention, as the measurement method of the development rate, as illustrated in FIG. 1, a photosensitive material provided with an unexposed photosensitive layer on an aluminum support was dipped in a certain alkaline developing solution (30° C.) having a pH in the range of from 10 to 13.5, and the dissolution behavior of the photosensitive layer was examined using a DRM interference wave measuring instrument. FIG. 1 is an outline view of a DRM interference wave measuring instrument for measuring the dissolution behavior of the photosensitive layer. In the invention, the change of the film thickness was detected by interference using light of 640 nm. In the case where the development behavior is non-swelling development from the surface of the photosensitive layer, the film thickness becomes gradually thin with the progress of the development time, whereby an interference wave corresponding to the thickness is obtained. Also, in the case of swelling dissolution (film-removing dissolution), since the film thickness changes by the penetration of the developing solution, a distinct interference wave is not obtained.

By continuing the measurement under this condition, the development rate can be determined from the time when the photosensitive layer is completely removed so that the film thickness becomes zero (development completion time) and the film thickness (μm) of the photosensitive layer according to the following equation. As the development rate increases, the film is more easily removed by the developing solution and judged to be good in the developability.
[Development rate (of unexposed areas)]=[Thickness (μm) of photosensitive layer/Recording completion time (sec)]
Measurement of Penetration Rate of the Alkaline Developing Solution

Also, the penetration rate of the alkaline developing solution as referred to herein is a value showing a change rate of the electrostatic capacity (F) in the case where the foregoing photosensitive layer is subjected to film formation on a conductive support and dipped in the developing solution.

In the invention, as the measurement method of the electrostatic capacity which can be a standard of the penetration property, there is enumerated a method in which as illustrated in FIG. 2, a photosensitive material provided with a photosensitive layer (expressed by a recording layer in FIG. 2) prepared by exposing an aluminum support at a prescribed dosage and then curing is dipped as an electrode of one side in a certain alkaline developing solution (28° C.) having a pH in the range of from 10 to 13.5, a lead wire is connected to the aluminum support, a usual electrode is used as an electrode of the other side, and a voltage is applied. After applying the voltage, the developing solution penetrates into an interface between the support and the photosensitive layer with a lapse of the dipping time, whereby the electrostatic capacity changes.

The penetration rate of the developing solution can be determined from time (s) required until the electrostatic capacity changes and the film thickness (μm) of the photo-sensitive layer according to the following equation. It is judged that the smaller the penetration rate, the lower the penetration property of the developing solution is.
[Penetration rate of developing solution (of exposed areas)][Thickness (μm) of photosensitive layer/Time (s) required until the change of the electrostatic capacity becomes constant]
As preferred physical properties of the photosensitive layer in the lithographic printing plate precursor of the invention, the development rate of unexposed areas by an alkaline developing solution having a pH of from 10 to 13.5 according to the foregoing measurement is preferably from 80 to 400 nm/sec, and the penetration rate of the same alkaline developing solution into the photosensitive layer according to the foregoing measurement is preferably not more than 90 nF/sec. Also, the development rate of unexposed areas by an alkaline developing solution having a pH of from 10 to 13.5 according to the foregoing measurement is more preferably from 90 to 200 nm/seq, and the penetration rate of the same alkaline developing solution into the photosensitive layer according to the foregoing measurement is more preferably not more than 80 nF/sec. The upper limit of the development rate or the lower limit of the penetration rate is not particularly limited. But, taking into consideration a balance therebetween, the development rate of unexposed areas is more preferably in the range of from 90 to 200 nm/sec, and the penetration rate of the same alkaline developing solution into the photosensitive layer is more preferably not more than 80 nF/sec.

The development rate of unexposed areas of the photo-sensitive layer and the penetration rate of the alkaline developing solution into the photosensitive layer after curing can be controlled in the customary manner. As representative examples, the addition of a hydrophilic compound is useful for an enhancement of the development rate of unexposed areas, and a measure for adding a hydrophobic compound is useful in inhibiting the penetration of the developing solution into exposed areas.

By using the foregoing specified binder polymer, it is possible to easily adjust the development rate of the photosensitive layer and the penetration rate of the developing solution at the foregoing preferred ranges, respectively.

Protective Layer

Since the photosensitive layer of the lithographic printing plate precursor of the invention is a heat polymerizable negative working photosensitive layer, for the purpose of performing the exposure in air, it is preferred to further provide a protective layer (also called as “overcoat layer”) on the photosensitive layer. Though the protective layer is basically provided for the purpose of protecting the photosensitive layer, in the case where the photosensitive layer has a radical polymerizable image forming mechanism as in the invention, the protective layer plays a role as an oxygen shielding layer, and in the case where the photosensitive layer is exposed with infrared laser having a high luminance, the protective layer plays a role as an abrasion preventing layer.

Also, in addition to the foregoing roles, the protective layer is further required to have characteristics such that it does not substantially hinder permeation of light to be used for the exposure; that it has excellent adhesion to the photosensitive layer; and that it can he readily removed in the development step after the exposure. With respect to such a protective layer, there have hitherto been made various devices, the details of which are described in U.S. Pat. No. 3,458,311 and JP-B-55-49729.

As materials that can be used for the protective layer, water-soluble polymer compounds having relatively excellent crystallinity can be used. Specific examples thereof include water-soluble polymers such as polyvinyl alcohol, vinyl alcohol/vinyl phthalate copolymers, vinyl acetate/vinyl alcohol/vinyl phthalate copolymers, vinyl acetate/crotonic acid copolymers, polyvinylpyrrolidone, acidic celluloses, gelatin, gum arabic, polyacrylic acid, and polyacrylamides. These materials can be used singly or in admixture. Above all, use of polyvinyl alcohol as the major component gives the best results with respect to basic characteristics such as oxygen shielding property and development removal property.

The polyvinyl alcohol to be used in the protective layer may be partially substituted with an ester, an ether, or an acetal so far as it contains an unsubstituted vinyl alcohol unit for the sake of having necessary oxygen shielding property and water solubility. Also, the polyvinyl alcohol may partly have other copolymerization components. In particular, a mixture in which the polyvinyl alcohol is substituted with polyvinylpyrrolidone in the range of from 15 to 50% by weight is preferable from the viewpoint of storage stability.

Specific examples of the polyvinyl alcohol include those having been hydrolyzed to an extent of from 71 to 100% by mole and having a weight average molecular weight in the range of from 300 to 2,400.

Specific examples includes PVA-105, PVA-110, PVA-117, PVA-117H, PVA-120, PVA-124, PVA-124H, PVA-CS, PVA-CST, PVA-HC, PVA-203, PVA-204, PVA-205, PVA-210, PVA-217, PVA-220, PVA-224, PVA-217EE, PVA-217E, PVA-220E, PVA-224E, PVA-405, PVA-420, PVA-613, and L-8 (all of which are manufactured by Kuraray Co., Ltd.).

Components of the protective layer (inclusive of selection of PVA and use of additives), coating amount, etc. are selected while taking into account oxygen shielding property, development removal property, fogging, adhesion, and scuff resistance. In general, the higher the degree of hydrolysis of PVA to be used (the higher the content of unsubstituted vinyl alcohol unit in the protective layer) and the thicker the film thickness, the higher the oxygen shielding property is, and therefore, such is advantageous on the point of sensitivity. However, where the oxygen shielding property is extremely increased, there are caused problems such that unnecessary polymerization reaction takes place at the time of manufacture and unprocessed stock storage and that unnecessary fogging and thickening of image lines are generated at the time of image exposure.

Accordingly, it is preferable that the oxygen permeation (A) at 25° C. at 1 atm. is satisfied with the relation: 0.2≦A≦20 (cc/m²·day).

With respect to the foregoing (co)polymers such as polyvinyl alcohol (PVA), those having a molecular weight in the range of from 2,000 to 10,000,000, and preferably from 20,000 to 3,000,000 can be suitably used.

As other composition of the protective layer, by adding glycerin, dipropylene glycol, or the like in an amount corresponding to several % by weight to the (co)polymer, it is possible to impart flexibility. Also, it is possible to add an anionic surfactant (for example, sodium alkylsulfates and sodium alkylsulfonates), an ampholytic surfactant (for example, alkylaminocarboxylic acid salts and alkylamino-dicarboxylic acid salts), or a nonionic surfactant (for example, polyoxyethylene alkylphenyl ethers) in an amount of several % by weight to the (co)polymer.

The film thickness of the protective layer is suitably from 0.5 to 5 μm, and especially suitably from 0.5 to 2 μm.

Also, adhesion to image areas and scuff resistance are extremely important in handling printing plates. That is, when a hydrophilic layer made of a water-soluble polymer is laminated on a lipophilic polymerization layer, film separation is liable to take place due to shortage of adhesive force, whereby the separated part causes defects such as poor film curing due to polymerization inhibition by oxygen. In this regard, various proposals have been made for improving the adhesion between these two layers. For example, it is described in U.S. Patent Application Serial Nos. 292,501 and 44,563 that by mixing from 20 to 60% by weight of an acrylic emulsion or a water-insoluble polyvinylpyrrolidone-vinyl acetal copolymer in a hydrophilic polymer mainly composed of polyvinyl alcohol and laminating the mixture on a polymerization layer, sufficient adhesion is obtained. For the protective layer in the invention, any of these known technologies can be applied. Coating methods of such a protective layer are described in detail in, for example, U.S. Pat. No. 3,458,311 and JP-A-55-49729.

Plate Making

For the sake of performing plate making of the lithographic printing plate precursor of the invention, at least exposure and development processes are carried out.

As light sources for exposing the lithographic printing plate precursor of the invention, infrared lasers are suitable. Also, thermal recording can be carried out using an ultraviolet lamp or a thermal head.

Above all, in the invention, it is preferable that image exposure is carried out using solid lasers or semiconductor lasers capable of radiating infrared light having a wavelength of from 750 nm to 1,400 nm. The output of the laser is preferably 100 mW or more, and for the sake of shortening the exposure time, it is preferable to use a multi-beam laser device. Also, it is preferable that the exposure time per pixel is within 20 μsec. Energy to be irradiated on the lithographic printing plate precursor is preferably from 10 to 300 mJ/cm². When the exposure energy is too low, curing of the image recording layer may not possibly proceed sufficiently. On the other hand, when the exposure energy is too high, the image recording layer is subjected to abrasion with laser, whereby the image may possibly be injured.

In the invention, exposure can be carried out by overlapping light beams as the light source. The overlap means that the sub-scanning pitch width is smaller than the beam size. For example, when the beam size is expressed in terms of full width at half maximu (FWHM), the overlap can be quantitatively expressed by FWHM/sub-scanning pitch width (overlap coefficient). In the invention, it is preferable that the overlap coefficient is 0.1 or more.

The scanning system of the light source of the exposure device that is used in the invention is not particularly limited, and a cylinder external surface scanning system, a cylinder internal surface scanning system, and a planar scanning system can be employed. Also, the channel of the light source may be of a single channel or multi-channel mode, but in the case of a cylinder external surface scanning system, a multi-channel mode is preferably employed.

In the invention, the development treatment may be carried out immediately after the exposure, or heat treatment may be carried out between the exposure step and the development step. With respect to the heat treatment condition, it is preferable that the heat treatment is carried out at a temperature in the range of from 60 to 150° C. for from 5 seconds to 5 minutes.

The heat treatment can be properly chosen from a variety of the conventionally known methods. Specific examples thereof include a method of heating the lithographic printing plate precursor while bringing it into contact with a panel heater or ceramic heater; and a method of non-contact heating by a lamp or warm air, By undergoing the foregoing heat treatment, it is possible to reduce the amount of laser energy necessary for image recording in the laser to be irradiated.

Also, in case where the lithographic printing plate precursor has a protective layer, pre-water washing for removing the protective layer may be carried out prior to the development step. For example, the pre-water washing is carried out in a method in which water is discharged from a spray pipe on the surface of the protective layer of the lithographic printing plate precursor, and after wetting, the protective layer is removed using a brush roller. For example, tap water is used for the pre-water washing. Also, in the case where the development step is carried out by an automatic processor, the pre-water washing may be carried out within the automatic processor.

The lithographic printing plate precursor of the invention is subjected to development treatment after the exposure as it is, or after the heating step or the pre-water washing step. As a developing solution to be used in the development treatment, alkaline aqueous solutions having a pH of not more than 14 are especially preferable. More preferably, alkaline aqueous solutions having a pH of from 8 to 12 and containing an anionic surfactant are used. Examples thereof include inorganic alkaline agents such as sodium tertiary phosphate, potassium tertiary phosphate, ammonium tertiary phosphate, sodium secondary phosphate, potassium secondary phosphate, ammonium secondary phosphate, sodium carbonate, potassium carbonate, ammonium carbonate, sodium hydrogencarbonate, potassium hydrogencarbonate, ammonium hydrogencarbonate, sodium borate, potassium borate, ammonium borate, sodium hydroxide, ammonium hydroxide, potassium hydroxide, and lithium hydroxide. Also, organic alkaline agents such as monomethylamine, dimethylamine, tri-methylamine, monoethylamine, diethylamine, triethylamine, monoisopropylamine, diisopropylamine, triisopropylamine, n-butylamine, monoethanolamine, diethanolamine, triethanolamine, monoisopropanolamine, diisopropanolamine, ethyleneimine, ethylenediamine, and pyridine can be used. The alkaline agent is used singly or in combination of two or more thereof.

Also, in the development treatment of the lithographic printing plate precursor of the invention, an anionic surfactant is usually added in an amount of from 1 to 20% by weight, and preferably from 3 to 10% by weight in the developing solution. When the amount of the anionic surfactant is too small, the developability becomes worse. On the other hand, when it is too large, there are caused harmful influences, for example, deterioration of the strength such as abrasion resistance of the image. Examples of anionic surfactants include a sodium salt of lauryl alcohol sulfate, an ammonium salt of lauryl alcohol sulfate, a sodium salt of octyl alcohol sulfate, alkylarylsulfonic acid slats (for example, a sodium salt of isopropylnaphthalenesulfonic acid, a sodium salt of isobutylnaphthalenesulfonic acid, a sodium salt of polyoxyethylene glycol mononaphthyl ether sulfuric acid ester, a sodium salt of dodecylbenzenesulfonic acid, and a sodium salt of m-nitrobenzenesulfonic acid), sulfuric acid esters of a higher alcohol having from 8 to 22 carbon atoms (for example, secondary sodium alkyl sulfates), aliphatic alcohol phosphoric acid esters (for example, a sodium salt of cetyl alcohol phosphoric acid ester), sulfonic acid salts of an alkylamide (for example, C₁₇H₃₃CON(CH₃) CH₂CH₂SO₃Na), and sulfonic acid salts of a dibasic aliphatic ester (for example, sodium sulfosuccinic acid dioctyl ester and sodium sulfosuccinic acid dihexyl ester).

Also, an organic solvent capable of being mixed with water, such as benzyl alcohol, may be added to the developing solution, if desired. As the organic solvent, those having a solubility in water of not more than about 10 t by weight, and preferably not more than 5% by weight are chosen. Examples thereof include 1-phenylethanol, 2-phenylethanol, 3-phenylpropanol, 1,4-phenylbutanol, 2,2-phenylbutanol, 1,2-phenoxyethanol, 2-benzyloxyethanol, o-methoxybenzyl alcohol, m-methoxybenzyl alcohol, p-methoxybenzyl alcohol, benzyl alcohol, cyclohexanol, 2-methylcyclohexanol, 4-methylcyclohexanol, and 3-methylcyclohexanol. The content of the organic solvent is suitably from 1 to 5% by weight based on the total weight of the developing solution at the time of use. Its use amount is closely related to the amount of the surfactant to be used, and it is preferred to increase the amount of the anionic surfactant with the increase of the organic solvent. This is because when the amount of the organic solvent is increased in the state that the amount of the anionic surfactant is small, the organic solvent does not dissolve the anionic surfactant therein, and therefore, securance of good developability cannot be expected.

Also, additives such as a defoaming agent and a hard water softener may further be contained, if desired. Examples of hard water softeners include polyphosphoric acid salts (for example, Na₂P₂O₇, Na₂P₃O₃, Na₃P₃O₉₁ Na₂O₄P(Nao₃P)PO₃Na₂, and Calgon (poly(sodium metaphosphate))); amino polycarboxylic acids (for example, ethylenediaminetetraacetic acid and its potassium salt and sodium salt; diethylenetriamine-pentaacetic acid and its potassium salt and sodium salt; triethylenetetraminehexaacetic acid and its potassium salt and sodium salt; hydroxyethyl ethylenediaminetriacetic acid and its potassium salt and sodium salt; nitrilotriacetic acid and its potassium salt and sodium salt; 1,2-diamino-cyclohexanetetraacetic acid and its potassium salt and sodium salt; and 1,3-diamino-2-propanoltetraacetic acid and its potassium salt and sodium salt); other polycarboxylic-acids (for example, 2-phosphonobutanetricarboxylic acid-1,2,4 and its potassium salt and sodium salt; and 2-phospho-butanonetricarboxylic acid-2,3,4 and its potassium salt and sodium salt); and organic phosphonic acids (for example, 1-phosphonoethanetricarboxylic acid-1,2,2 and its potassium salt and sodium salt; 1-hydroxyethane-1,1-diphosphonic acid and its potassium salt and sodium salt; and aminotri-(methylenephosphonic acid) and its potassium salt and sodium salt). The optimum amount of the hard water softener varies depending upon the hardness of hard water to be used and its use amount, but the hard water softener is generally used in an amount in the range of from 0.01 to 5% by weight, and preferably from 0.01 to 0.5% by weight in the developing solution at the time of use.

Further, in the case where the lithographic printing plate precursor is developed using an automatic processor, since the developing solution fatigues corresponding to the treatment amount, a treatment ability may be recovered using a replenisher or a fresh developing solution. In this case, it is preferable to carry out the replenishment by the method described in U.S. Pat. No. 4,882,246. Also, developing solutions described in JP-A-50-26601, JP-A-58-54341, JP-B-56-39464, JP-B-56-42860, and JP-B-57-7427 are preferable.

The lithographic printing plate precursor thus developed may be subjected to post treatment with, for example, washing water, a rinse solution containing a surfactant, etc., and a desensitizing solution containing gum arabic or starch derivatives as described in JP-A-54-8002, JP-A-55-115045, and JP-A-59-58431. In the post treatment of the lithographic printing plate precursor of the invention, these treatments can be employed through a variety of combinations.

In plate making of the lithographic printing plate precursor of the invention, for the purpose of enhancing the image strength and resistance to printing, it is effective to undergo entire post heating or entire exposure against an image after the development.

A very strong condition can be applied to heating after the development. In general, the heat treatment is carried out at a temperature in the range of from 200 to 500° C. When the heating temperature after the development is too low, a sufficient image-reinforcing action cannot be obtained. On the other hand, when it is too high, problems such as deterioration of the support and heat decomposition of image areas may possibly occur.

The lithographic printing plate obtained through the foregoing treatments is fixed in an offset printing machine and used for producing a number of prints.

As a plate cleaner that is used for the purpose of removing stains on the plate at the time of printing, conventionally known plate cleaners for PS plate are employed, and examples thereof include CL-1, CL-2, CP, CN-4, CN, CG-1, PC-1, SR, and IC (all of which are manufactured by Fuji Photo Film Co., Ltd.).

### EXAMPLES

The invention will be described below with reference to the following Examples, but it should not be construed that the invention is limited thereto.

### Examples 1 to 5

Preparation of Support

Using an aluminum plate of JIS A1050 having a thickness of 0.30 mm and a width of 1,030 mm, the following surface treatment was carried out.

Surface Treatment

The surface treatment was carried out by continuously performing the following various treatments (a) to (f). Incidentally, after each treatment and water washing, draining was carried out using nip rollers.

(a) The aluminum plate was subjected to an etching treatment at a sodium hydroxide concentration of 26% by weight and an aluminum ion concentration of 6.5% by weight and at a temperature of 70° C., thereby dissolving 5 g/m² of the aluminum plate. Thereafter, the aluminum plate was washed with water.

(b) The aluminum plate was subjected to a desmutting treatment by spraying an aqueous solution having a nitric acid concentration of 1% by weight (containing 0.5% by weight of an aluminum ion) and having a temperature of 30° C., followed by washing with water.

(c) An electrochemical roughing treatment was continuously carried out using an alternating voltage of 60 Hz. At this time, the used electrolytic liquid was an aqueous solution of 1% by weight of nitric acid (containing 0.5% by weight of an aluminum ion and 0.007% by weight of an ammonium ion) and having a temperature of 30° C. The electrochemical roughing treatment was carried out using a carbon electrode as a counter electrode and using a trapezoid rectangular wave alternating current having a time (TP) of from zero to a peak of the current value of 2 msec and a duty ratio of 1/1 as an alternating current power source. Ferrite was used as an auxiliary anode. The current density was 25 A/dm² in terms of the peak value of current, and the quantity of electrification was 250 C/dm² in terms of total sum of quantities of electrification when the aluminum plate functioned as an anode. For the auxiliary anode, 5% of the current having passed from the power source was shunted. Thereafter, the aluminum plate was washed with water.

(d) The aluminum plate was subjected to an etching treatment at 35° C. by spraying at a sodium hydroxide concentration of 26% by weight and an aluminum ion concentration of 6.5% by weight, thereby dissolving 0.2 g/m² of the aluminum plate and removing smut components mainly composed of aluminum hydroxide formed when the preceding electrochemical roughing treatment was carried out using an alternating current. Also, an edge portion of the formed pit was dissolved to make the edge portion smooth. Thereafter, the aluminum plate was washed with water.

(e) The aluminum plate was subjected to a desmutting treatment by spraying an aqueous solution having a sulfuric acid concentration of 25% by weight (containing 0.5% by weight of an aluminum ion) and having a temperature of 60° C., followed by washing with water by spraying.

(f) The aluminum plate was subjected to an anodic oxidation treatment at a sulfuric acid concentration of 170 g/L (containing 0.5% by weight of an aluminum ion) and a temperature of 33° C. and at a current density of 5 (A/dm²) for 50 seconds. Thereafter, the aluminum plate was washed with water. At this time, the weight of the anodically oxidized film was 2.7 g/m².

The thus obtained aluminum support had a surface roughness (Ra) of 0.27 (measuring instrument; Surfcom, manufactured by Tokyo Seimitsu Co., Ltd., probe tip diameter: 2 μm) and a surface area ratio (AS) of 75% and a degree of steepness (a45) of 44% (measuring instrument: sPA300/SPI3800N, manufactured by Seiko Instruments Inc.), respectively.

Undercoat layer

Next, the following coating solution for undercoat layer was coated on the aluminum support using a wire bar and dried at 90° C. for 30 seconds. The coating amount was 10 mg/m². Incidentally, the relationship between the kind of a polymer compound having an acid group according to the invention and the lithographic printing plate precursor in each of Examples 1 to 5 is shown in Table 2.

| | |
|---|---|
| Polymer compound having an acid group according to | 0.1 g |
| the invention (kind shown in Table 1) | |
| Methanol: | 27 g |
| Ion-exchanged water: | 3 g |

TABLE 1

| | Polymer | Polymer | Polymer | Polymer | Polymer |
|---|---|---|---|---|---|
| Component | compound A | compound B | compound C | compound D | compound E |
| Methyl | 60 | 30 | — | — | 40 |
| methacrylate | | | | | |
| N-t-Butyl | — | — | 40 | 50 | — |
| acrylamide | | | | | |
| Ethyl acrylate | 25 | — | — | — | — |
| Methyl | — | 40 | 40 | 30 | 40 |
| acrylate | | | | | |
| Sodium | — | 30 | 10 | — | — |
| p-styrenesulfonate | | | | | |
| Sodium | 15 | — | 10 | 15 | 10 |
| 2-acrylamido-2- | | | | | |
| methyl- | | | | | |
| propanesulfonate | | | | | |
| Sodium | — | — | — | 5 | — |
| vinylsulfonate | | | | | |
| Methacrylic | — | — | — | — | 10 |
| acid | | | | | |
| Weight average | 30,000 | 80,000 | 40,000 | 20,000 | 60,000 |
| molecular | | | | | |
| weight | | | | | |

Photosensitive Layer

Next, the following coating solution for photosensitive layer [P-1] was prepared and coated on the foregoing aluminum plate using a wire bar. Drying was carried out at 122° C. for 27 seconds using a warm air drying device, to obtain a lithographic printing plate precursor. The coating amount after drying was 1.3 μl².

<Coating solution for photosensitive layer [P-1]>

| | |
|---|---|
| Infrared absorber (IR-1): | 0.074 g |
| Polymerization initiator (OS-12): | 0.280 g |
| Additive (PM-1): | 0.151 g |
| Polymerizable compound (AM-1): | 1.00 g |
| Binder polymer (BT-1): | 1.00 g |
| Ethyl Violet (C-1): | 0.04 g |
| Fluorine based surfactant (Megaface F-780-F, | 10.4 g |
| manufactured by Dainippon Ink and Chemicals, | |
| Incorporated, a 30% by weight solution of | |
| methyl ethyl ketone (MIBK)): | |
| Methyl ethyl ketone: | 10.4 g |
| Methanol: | 4.83 g |
| 1-Methoxy-2-propanol: | 10.4 g |

Incidentally, the compound (OS-12) capable of generating a radical means one enumerated as an example of compounds of the onium salt represented by the foregoing formula (I).

The structures of the infrared absorber (IR-1), additive (PM-1), polymerizable compound (AM-1), binder polymer (BT-1), and Ethyl Violet (C-1) used in the foregoing coating solution for photosensitive layer are shown below. 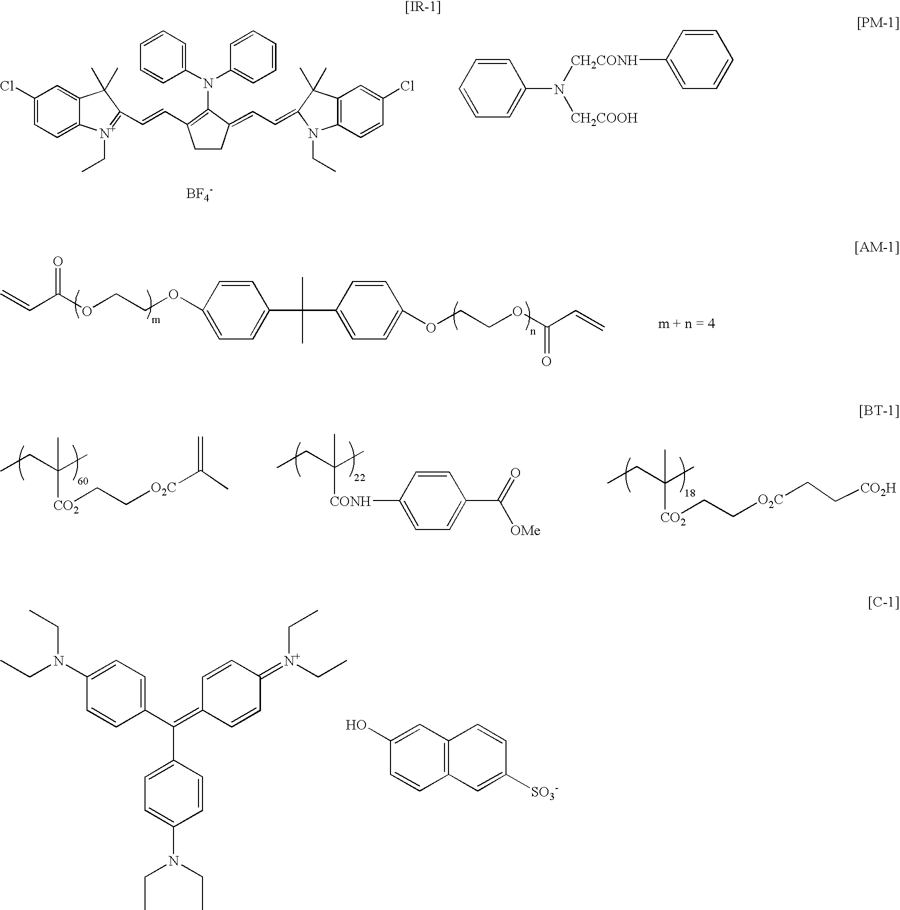
Protective Layer (Overcoat Layer)

A mixed aqueous solution of polyvinyl alcohol (degree of hydrolysis: 98% by mole, degree of polymerization: 500) and polyvinylpyrrolidone (Luviscol K-30, manufactured by BASF Corporation) was coated on the surface of the foregoing photosensitive layer using a wire bar and dried at 125° C. for 75 seconds using a warm air drying device. Incidentally, the content of polyvinyl alcohol/polyvinylpyrrolidone was 4/1% by weight, and the coating amount (coating amount after drying) was 2.30 g/m².

### Comparative Example 11

A lithographic printing plate precursor was prepared in the same manner as in Examples 1 to 5, except that in Examples 1 to 5, in the foregoing (c), the peak value of the current was set up at 30 A/dm², and the quantity of electrification was set up at 250 C/dm² in terms of the total sum of quantities of electrification when the aluminum plate functioned as an anode and that in (d), the etching treatment was carried out at 25° C., thereby dissolving 0.1 g/m² of the aluminum plate to prepare a support. The thus prepared aluminum support had a surface roughness (Ra) of 0.35, a surface area ratio (AS) of 80%, and a degree of steepness (a45) of 63%, respectively.

### Comparative Example 2

A lithographic printing plate precursor was prepared in the same manner as in Examples 1 to S, except that in Examples 1 to 5, in the foregoing (d), the etching treatment was carried out at 45° C., thereby dissolving 0.4 g/m² Of the aluminum plate to prepare a support. The thus prepared aluminum support had a surface roughness (Ra) of 0.27, a surface area ratio (AS) of 32%, and a degree of steepness (a45) of 20%, respectively.

### Comparative Example 3

A lithographic printing plate precursor was prepared in the same manner as in Examples 1 to 5, except that in Examples 1 to 5, no undercoat layer was provided.

Evaluation

(1) Sensitivity Evaluation:

Each of the thus obtained lithographic printing plate precursors was exposed using Creo's Trendsetter 3244VX mounted with a water-cooled 40-W infrared semiconductor laser at a resolution of 175 lpi and at a number of rotation of external drum of 150 rpm while changing an output by 0.15 in terms of log E within the range of from 0 to 8 W. Incidentally, the exposure was carried out under a condition at 25° C. and at a 50% RH. After the exposure, the protective layer was removed by washing with tap water, and the residue was developed at 30° C. for 12 seconds using LP-1310HII, manufactured by Fuji Photo Film Co., Ltd. A (1/4) water-diluted solution of DV-2, manufactured by Fuji Photo Film Co., Ltd. was used as a developing solution, and a (1/1) water-diluted solution of GN-2K, manufactured by Fuji Photo Film Co., Ltd. was used as a finisher.

A density of image areas of the lithographic printing plate obtained by the development was measured as a cyan density using a Macbeth reflection densitometer RD-918 and using a red filter equipped in the densitometer. The inverse number of the exposure amount necessary for obtaining the measured density of 0.8 was defined as an index of the sensitivity. Incidentally, the evaluation was made in such a manner that the sensitivity of the lithographic printing plate obtained in Example 1 was defined as 100, and the sensitivity of each of other lithographic printing plates was evaluated as a relative value thereto. The larger the value, the more excellent the sensitivity is. The results obtained are shown in Table 1.

(2) Evaluation of Unprocessed Stock Storability:

A lithographic printing plate precursor in the unexposed state was stored at 45° C. and 75% RH for 3 days, exposed and developed in the following manner, and a density of non-image areas was measured using a Macbeth reflection densitometer RD-918. Also, with respect to a lithographic printing plate precursor immediately after the preparation, exposure and development were carried out in the same manner, and a density of non-image areas was measured. In these Examples, a difference (Δ) in the density of non-image areas therebetween was determined and defined as an index of the unprocessed stock storability. The smaller the Δ value, the better the unprocessed stock storability is. Values of not more than 0.02 are at a level where there is no problem in the practical use. The results obtained are shown in Table 2.

(Exposure and Development)

The resulting lithographic printing plate precursor was exposed with a solid density image having a resolution of 175 lpi using Creo's Trendsetter 3244VX mounted with a water-cooled 40-W infrared semiconductor laser under conditions of an output of 8 W, a number of rotation of external drum of 206 rpm, and a plate surface energy of 100 mJ/cm². After the exposure, the protective layer was removed by washing with tap water, and the residue was developed in the same manner as in the development step of the evaluation of sensitivity (1).

(3) Evaluation of Resistance to Printing and Printing Staining Property:

The prepared lithographic printing plate precursor was exposed with an 80% separated mesh image having a resolution of 175 lpi using Creo's Trendsetter 3244VX mounted with a water-cooled 40-W infrared semiconductor laser under conditions of an output of 8 W, a number of rotation of external drum of 206 rpm, and a plate surface energy of 100 m/cm². After the exposure, the protective layer was removed by washing with tap water, and the residue was developed in the same manner as in the development step of the evaluation of sensitivity (1), to obtain a lithographic printing plate. Then, the resulting lithographic printing plate was printed using Lithrone (a printing machine, manufactured by Komori Corporation), and the printing was carried out while repeating works to wipe out the ink from the surface of the printing plate material using Multicleaner, manufactured by Fuji Photo Film Co., Ltd. every time of printing 10,000 sheets. Thus, the number of sheets having been completed for printing was defined as an index. The results obtained are shown in Table 2.

Also, at the time of evaluation of the resistance to printing, the ink stain of non-image areas was visually evaluated as the printing staining property (before forced elapsing) according to five grades. Further, the lithographic printing plate precursor was subjected to forced elapsing by storing at 45° C. and 75% RH for 3 days and evaluated as the printing staining property (after forced elapsing) in the same manner. The larger the numerical value, the more excellent the resistance to staining is. The evaluation level of 4 or more means that the lithographic printing plate precursor is at a practically useful level, and the evaluation level of 3 is a permissible lower limit. The results are shown in Table 2.

TABLE 2

| | Polymer | | Unprocessed | | Printing staining property | |
|---|---|---|---|---|---|---|
| | compound for | Sensitivity | stock | Resistance | (Before | (After |
| | undercoat | at 25° C. and | storability | to printing | forced | forced |
| | layer | 50% RH | Δfog | (sheets) | elapsing) | elapsing) |
| Example 1 | Polymer | 100 | 0 | 100,000 | 5 | 5 |
| | compound A | | | | | |
| Example 2 | Polymer | 100 | 0 | 100,000 | 5 | 5 |
| | compound B | | | | | |
| Example 3 | Polymer | 100 | 0 | 100,000 | 5 | 5 |
| | compound C | | | | | |
| Example 4 | Polymer | 100 | 0 | 100,000 | 5 | 5 |
| | compound D | | | | | |
| Example 5 | Polymer | 100 | 0 | 100,000 | 5 | 5 |
| | compound E | | | | | |
| Comparative | Polymer | 100 | +0.03 | 100,000 | 3 | 2 |
| Example 1 | compound A | | | | | |
| Comparative | Polymer | 100 | 0 | 50,000 | 5 | 5 |
| Example 2 | compound B | | | | | |
| Comparative | — | 100 | +0.08 | 100,000 | 4 | 1 |
| Example 3 | | | | | | |

As is clear from Table 2, it is noted that the lithographic printing plate precursors of Examples 1 to 5 are excellent with respect to all of the unprocessed stock stability, resistance to printing and printing staining property.

In contrast, it has been understood that since the lithographic printing plate precursor of Comparative Example 1 has a large a45 so that it falls outside the scope of the prescribed surface shape of the support of the invention, it is inferior with respect to the unprocessed stock stability and printing staining property; and that since the lithographic printing plate precursor of Comparative Example 2 has a small a45 and a small ΔS so that it also falls outside the scope of the prescribed surface shape of the support of the invention, it is inferior with respect to the resistance to printing. Also, it has become clear that since the lithographic printing plate precursor of Comparative Example 3 does not have an undercoat layer, it is inferior with respect to the unprocessed stock stability and printing staining property.

This application is based on Japanese Patent application JP 2003-329758, filed Sep. 22, 2003, the entire content of which is hereby incorporated by reference, the same as if set forth at length.

1. A lithographic printing plate precursor comprising, in this order, a support, an undercoat layer and a photosensitive layer containing an infrared absorber, a polymerization initiator, a polymerizable compound and a binder polymer, wherein
the undercoat layer contains a polymer compound having an acid group, and Ra, ΔS and a45 of a surface of the support are satisfied with the following conditions (i) to (iii), respectively:
(i) Ra: 0.2 to 0.40 μm
(ii) ΔS: 35 to 85 t
(iii) a45: 25 to 55%
in which
Ra represents a surface roughness,
ΔS is determined from a real area Sₓ determined by an approximate three-point method and a geometric measurement area S₀ and according to the following equation:
ΔS(%)=(Sₓ−S₀)/S₀×100
and
a45 represents an area rate of a part having a degree of inclination of 45° or more, which is obtained by extracting components having a wavelength of from 0.2 μm to 2 μm.

2. The lithographic printing plate precursor according to claim 1, wherein the polymer compound contains 20% by mole or more of a constitutional unit having an acid group in a side chain.

3. The lithographic printing plate precursor according to claim 1, wherein the acid group is —COOH, —SO₃H, —OSO₃H, —PO₃H₂, —OPO₃H₂, —CONHSO₂ or —SO₂NHSO₂.

4. The lithographic printing plate precursor according to claim 1, wherein the acid group is —COOH or —SO₃H.

5. The lithographic printing plate precursor according to claim 1, wherein the polymer compound has a sulfonic acid group or a carboxylic acid group.

6. The lithographic printing plate precursor according to claim 1, wherein the binder polymer has a repeating unit represented by the following formula (A): 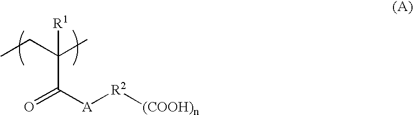
wherein R¹ represents a hydrogen atom or a methyl group; R² represents a connecting group constituted of one or more atoms selected from the group consisting of a carbon atom, a hydrogen atom, an oxygen atom, a nitrogen atom and a sulfur atom; A represents an oxygen atom or —NR³—; R³ represents a hydrogen atom or a monovalent hydrocarbon group having from 1 to 10 carbon atoms; and n represents an integer of from 1 to 5.

7. The lithographic printing plate precursor according to claim 1, wherein the polymerizable compound is an addition polymerizable compound containing at least one ethylenically unsaturated double bond.

8. The lithographic printing plate precursor according to claim 1, wherein the photosensitive layer further contains a heat polymerization inhibitor in an amount of 0.01% by weight to 5% by weight based on a weight of non-volatile components in the photosensitive layer.

9. The lithographic printing plate precursor according to claim 1, further comprising a protective layer containing a water-soluble polymer, so that the undercoat layer, the photosensitive layer and the protective layer are in this order.

10. The lithographic printing plate precursor according to claim 1, wherein the polymerization initiator is an onium salt.
